(19) United States
(12) Patent Application Publication
(10) Pub. No.: US 2004/0187417 A1
(43) Pub. Date: Sep. 30, 2004

(54) Changeable display system for the exterior of a house and ornaments for exterior window shutters

(76) Inventor: Paul J. Thomas, Baltimore, MD (US)

Correspondence Address: Paul J. Thomas, 1602 Park Dr., Baltimore, MD, 21222, US

(21) Appl. No.: 10/807,812

(22) Filed: Mar. 24, 2004

Related U.S. Application Data
(60) Provisional application No. 60/457,051, filed on Mar. 24, 2003.

(51) Int. Cl. E06B 1/04

(52) U.S. Cl. 52/311.1

(57) ABSTRACT

A readily changeable display system for a home's exterior comprising window shutters made of any suitable plastics, woods, metals, or the like having a variety of ornaments which may be attached to, or removed there from for presenting a unique easy to change thematic display that further accentuates the exterior windows of a home.

### FIELD OF THE INVENTION

The present invention relates to customization of the exterior of a house, and more particularly to a changeable display system for the exterior of a house, and ornaments which may be at least removably attached to at least exterior window shutters and/or presented thereon in a display system, which may be changeable.

### BACKGROUND OF THE INVENTION

Through the course of history, architecture has evolved and changed. Mass production strived to build many houses and other structures more quickly and efficiently. Nearly all-visible ornamentation was eliminated in an effort to cut costs, and to further streamline the process of mass-producing houses. Unfortunately, the mass production of houses creates a problem where most of the houses are very similar in appearance. Improvements in appearance to a house or property can be made by changing the color of paint, adding siding on the exterior of the house, adding an expensive addition or ornamentation to the exterior of the house. Exterior window shutters have been used for many years as a functional form of window protection and additionally as a non-functional form of window decoration. The aesthetic nature of exterior shutters provides a comforting accent for windows with many variations in structure, shape, size, color etc. The present invention enables persons to affordably customize and improve their homes appearance in a unique manor.

### BACKGROUND—DESCRIPTION OF PRIOR ART

The prior art shows previous attempts to decorate exterior shutters with decorative cut outs, wherein a predetermined decorative shape is cut out of a planar outer face portion of the exterior shutter to give the exterior shutter a permanent cut out decoration. Other exterior shutter hardware such as decorative hinges, shutter dogs, and tiebacks is shown in the prior art, which utilizes permanent mounting fasteners, permanent adhesives, or other means known in the art to permanently attach hardware to the exterior shutter, for providing a useful or functional purpose associated with the exterior shutter, or for providing imitation exterior shutter hardware as a permanent surface treatment which has no functional or useful purpose. Other permanent decorative plastic hardware that is sold typically for architectural applications has been alternately sold by some shutter companies or distributors and categorized as shutter hardware. A molded plastic or metal three-dimensional American eagle, which utilizes permanent mounting fasteners such as screws for attachment is an example of such shutter hardware. The American eagle may be permanently attached to each shutter within a set providing a permanent surface treatment for the shutters, which may not be changed without permanent damage to the shutters surfaces. There is also no prior art showing that the American eagle can be permanently attached to a shutter in combination with at least a second ornament having a different selected decoration to present a permanent surface treatment. The prior art also shows how the exterior shutter has been provided with permanent surface treatments such as paint, or surface treatments such as geometric shapes made of wood, plastic or similar materials which, in a manufacturing stage are permanently attached to the outer face of the exterior shutter in sets of two or three using permanent mounting fasteners, adhesives, or other attachment means known in the art. The geometric shapes may also be molded or carved in the shutters. The two or three geometric or similar like shapes are attached to the outer face of the exterior shutter in a predictable manor wherein all of the shapes are the same, and are further permanently attached about the outer face of the exterior shutter in an even and substantially spaced relationship. Other previous attempts to decorate shutters teach how a shutter may be slip covered with a vinyl cover having a decorative surface thereof. The vinyl cover is attached to the shutter using Velcro strips which are positioned along the top and bottom edges of the shutter adjacent the facial portion, and along the top and bottom end portions of the inner face of the vinyl cover, whereby the vinyl cover may be removably attached to the top and bottom edges of the shutter in a taut manor and removed when desired. Such displays can also be expensive, and are not easily installed. The vinyl covers are each made in a one size fits all piece, which means that the covers have to be measured and cut to fit the exterior shutters. The covers also present an unforeseen mounting defect wherein any one of the covers act as a sail on a windy day as the wind gets behind the covers, and in many cases will blow the covers off the exterior shutters causing the homeowner aggravation and additional work.

From the above discussion, it can be readily appreciated that the prior art does not show exterior shutters, which may, without substantially altering the process, be manufactured, packaged and shipped to the consumer each having at least one ornament removably attached to at least a portion of at least planar surface which may be on, or about the outer face thereof. Nor does the prior art show exterior shutters which may be molded or made out of materials such as, for example, plastic, wood, or similar like materials and further having ornaments removably attached to at least a portion of at least planar surface which may be on, or about the outer face thereof, which are not effected by extreme weather conditions and/or damaging to the exterior shutters surfaces. The prior art also does not show how ornaments may be layered atop one another in a removable fashion to present a changeable appearance for shutters. The prior art additionally does not show a variety of variable methods of permanent surface treatment which may be afforded the exterior shutters, or the many other objects and obvious advantages pertaining to the present invention about to be disclosed herein.

### OBJECTS OF THE INVENTION

It is an object of the present invention to provide a changeable display system for the exterior of a house and a method of furnishing the exterior of the house with the changeable display system, which may further be provided as a kit or kits.

It is further an object of the present invention to provide ornaments for exterior window shutters that may be removably attached to at least a portion of at least planar surface, which may be on, or about the outer face of the exterior shutters.

It is still further an object of the present invention to provide ornaments for exterior shutters, which may be made of at least one decorative element.

It is still even further an object of the present invention to provide ornaments for exterior shutters, which may be made by permanently attaching or assembling a plurality of decorative elements together.

It is further an object of the present invention to provide ornaments for exterior shutters that are each capable of receiving at least one ornament, which may be removably attached to at least a portion of surface which may be on, or about the outer face thereof.

It is still further an object of the present invention to provide a permanently mounted, changeable display system for the exterior of a house having exterior shutters adjacent to windows.

It is an object of the present invention to provide decorative ensembles for exterior shutters, which may be removably attached to at least a portion of at least planar surface, which may be on, or about the outer face of the exterior shutters.

It is still even further an object of the present invention to provide removable ornaments for exterior shutters which may be used as a home improvement to enhance and/or add beauty to the exterior appearance of a house, whereby the inherent value and/or salability of the house may increase as a direct result.

It is further an object of the present invention to provide ornaments, which may be presented in a changeable display system on the exterior shutters of a house to express or communicate any desirable message.

It is still farther an object of the present invention to provide ornaments, which may be presented in a changeable display system on the exterior shutters of a house and may be left in place for years, or changed in an instant without leaving any resulting damage to the exterior shutters.

It is an object of the present invention to provide a variety of variable methods of permanent surface treatment, each of which may be used as desired when treating at least a portion and/or portions of surface, which may be on, or about the outer face of each exterior shutter within at least one set.

It is another object of the present invention to provide a method of improving the exterior appearance of a house having exterior shutters adjacent to windows, in an easy to change fashion.

It is still even further an object of the present invention to provide a method of changing the exterior appearance of a window having exterior shutters adjacent thereto.

It is further an object of the present invention to provide a method of decorating the exterior appearance of a window having exterior shutters adjacent thereto.

It is still further an object of the present invention to provide a method of coordinating a thematic display for the exterior of a house having exterior shutters thereon.

It is last but not least, an object of the present invention to provide a method of presenting a combination day and night display system on at least one set of exterior shutters adjacent to at least one window.

### BRIEF SUMMARY OF THE INVENTION

In accordance with the teachings of the present invention, there is disclosed a changeable display system for a house and also a method of furnishing the exterior the house with the changeable display system, and removable decorative ornaments which may be removably attached to exterior window shutters and/or presented thereon in a display system which may be changeable. A plurality of exterior window shutters is provided in combination with a plurality of ornaments having selected decorations, which collectively represent a theme. The exterior shutters, in a manufacturing stage are each made having an inner face, an outer face, side edges adjacent the inner face and outer face, the inner face and outer face further having at least portions of at least planar surface thereof, and at least one ornament which may be removably attached to at least a portion of at least planar surface which may be on, or about the outer face thereof. The exterior shutters each having at least one ornament on, or about the outer face thereof, are further disposed upon the exterior of the house adjacent to at least one window to present an instant display system which may be easily changed as desired. The ornaments may be easily removed from the outer face of the exterior shutters whenever desired and other ornaments having different selected decorations may be removably attached on, or about the outer face of the exterior shutters to dramatically improve or change the exterior appearance of the house. The exterior shutters, each having at least one ornament thereon, may be paired in sets of at least two and sold as a kit or kits. The kits are comprised of at least one set of exterior shutters, the mounting hardware therefore, and at least one set and/or any possible variable combination of sets of ornaments, which may further be removably attached to the exterior shutter. The kits are also afforded all the amenities that are to be disclosed herein and further related to the present invention, whereby the kits are afforded nearly endless possible presentation combinations which may even further include thematically matched decorative house flags and/or door mats etc.

The ornaments of the present invention each have a structural body which is preferably substantially smaller in relation as compared to the height and width dimensions of the exterior shutters, and are each further comprised of at least one decorative element which is defined herein as, at least a portion of suitable material having at least a predetermined shape and/or at least a portion of decorative surface thereof, an inner face, and an outer face. The at least portion of decorative surface may be made on, or about the inner face and/or the outer face of the ornament. Means are provided for at least removably attaching at least a portion of at least planar surface, which may be on, or about the inner face of the ornament to at least a portion of at least planar surface, which may be on, or about the outer face of the exterior shutter.

There is further disclosed a plurality of decorative elements, which can be permanently attached together or assembled in any desirable fashion for the purpose of making the ornament. At least a portion of at least planar surface which may be on, or about at least one decorative element may be permanently attached or assembled to at least a portion of at least planar surface which may be on, or about either the inner face, or the outer face of at least a second decorative element for the purpose of making the ornament.

There is still further disclosed ornaments for exterior shutters, each further having at least one ornament which may be removably attached to at least a portion of at least planar surface which may be on, or about the outer face thereof. At least a portion of at least planar surface which may be on, or about the inner face of at least one ornament having a selected decoration, may be removably attached to at least a portion of at least planar surface which may be on, or about the outer face at least a second ornament having a selected decoration for providing an enhanced and/or changeable appearance thereto.

There is still even further disclosed a permanently mounted changeable display system for the exterior of a house having exterior shutters thereon. A plurality of ornamental base mounts, each having at least one ornament which may be removably attached to at least a portion of at least planar surface which may be on, or about the outer face thereof, are permanently attached to the exterior shutters of the house, whereby a permanently mounted changeable display system is presented on the exterior of the house which can be frequently changed as desired to provide an improved and/or changeable exterior appearance for the house having exterior shutters thereon.

There is further disclosed, a plurality of ornaments which may be removably attached to the exterior shutter in a predetermined grouping, each ornament within the grouping is positioned in a close proximity in relation to the other ornaments within the grouping, wherein all of the ornament's at least predetermined shapes and/or at least portions of decorative surface thereof further cooperate collectively as a group to present a single display or decorative ensemble.

There is still further disclosed removable ornaments for exterior shutters which may be used as a home improvement, providing an exquisite appearance for the exterior of a house and substantially further adding beauty to the exterior appearance of the house, whereby the inherent value and/or salability of the house may increase as a direct result.

There is still even further disclosed ornaments for exterior shutters which can be presented in a changeable display system on the exterior shutters of a house to effectively communicate or express any desirable message. The at least predetermined shape and/or at least portion of decorative surface which may be on, or about the inner face and/or the outer face of the ornaments, may be designed to present a message of any suitable subject material to any persons whom may pass by the house and see and/or receive the presented message on the exterior shutters of the house.

There is further disclosed ornaments for exterior shutters which may be left in place, in a changeable display system on the exterior shutters for years, or may be easily changed as frequently as desired without causing any damage to the exterior shutters.

There is still further disclosed, a variety of variable methods of permanent surface treatment, each of which may be used as desired when treating at least a portion and/or portions of surface, which may be on the outer face of each exterior shutter within at least one set. A plurality of exterior shutters is provided along with a plurality of ornaments, the ornaments each having a selected decoration and further possessing photoluminescent like qualities. At least one of the ornaments having a selected decoration and further possessing photo-luminescent like qualities is permanently attached to one of the exterior shutters. At least a second ornament having the same selected decoration and further possessing photo-luminescent like qualities is permanently attached to the other exterior shutter within the at least one set wherein the selected decorations are directed to a theme and a display system related to the theme is presented which may further glow in the dark. A plurality of exterior shutters is provided along with a plurality of ornaments, each ornament further having a selected decoration. One of the ornaments having a selected decoration is permanently attached to one of the exterior shutters. At least a second ornament having a different selected decoration is permanently attached to the same exterior shutter wherein the selected decorations are directed to a theme. The permanent attaching of ornaments is repeated on the other exterior shutter within the at least one set to present a display system related to the theme. A plurality of exterior shutters is provided along with a plurality of ornaments, each ornament further having a selected decoration. One of the ornaments having a selected decoration is permanently attached to one of the exterior shutters. At least a second ornament having a different selected decoration is permanently attached to the same exterior shutter wherein the selected decorations are, in a complimenting fashion, directed to at least two different themes. The permanent attaching of ornaments is repeated on the other exterior shutter within the at least one set to present a display system related to at least two different themes which are further aesthetically complimenting of one another. A plurality of exterior shutters is provided along with a plurality of decorative ensembles, each decorative ensemble further having a selected decoration. At least one of the decorative ensembles having a selected decoration is permanently attached to one of the exterior shutters. At least a second decorative ensemble having the same selected decoration is permanently attached to the other exterior shutter within the at least one set wherein the selected decorations are directed to a theme, and a display system related to the theme is presented. A plurality of exterior shutters is provided along with a plurality of decorative ensembles, each decorative ensemble further having a selected decoration. One of the decorative ensembles having a selected decoration is permanently attached to one of the exterior shutters. At least a second decorative ensemble having a different selected decoration is permanently attached to the same exterior shutter wherein the selected decorations are directed to a theme. The permanent attaching of decorative ensembles is repeated on the other exterior shutter within the at least one set to present a display system related to the theme. A plurality of exterior shutters is provided along with a plurality of decorative ensembles, each decorative ensemble further having a selected decoration. One of the decorative ensembles having a selected decoration is permanently attached to one of the exterior shutters. At least a second decorative ensemble having a different selected decoration is permanently attached to the same exterior shutter wherein the selected decorations are, in a complimenting fashion, directed to at least two different themes. The permanent attaching of decorative ensembles is repeated on the other exterior shutter within the at least one set to present a display system related to at least two different themes which are further aesthetically complimenting of one another. A plurality of exterior shutters is provided along with a plurality of decorative ensembles and ornaments, each of the decorative ensembles and ornaments further having a selected decoration. At least one of the decorative ensembles having a selected decoration is permanently attached to one of the exterior shutters. At least one of the ornaments having a different selected decoration is permanently attached to the same exterior shutter wherein the selected decorations are directed to a theme. The permanent attaching of decorative ensembles and ornaments is repeated on the other exterior shutter within the at least one set to present a display system related to the theme. A plurality of exterior shutters is provided along with a plurality of decorative ensembles and ornaments, the decorative ensembles and ornaments each further having a selected decoration. At least one of the decorative ensembles having a selected decoration is permanently attached to one of the exterior shutters. At least one of the ornaments having a different selected decoration is permanently attached to the same exterior shutter wherein the selected decorations are, in a complimenting fashion, directed to at least two different themes. The permanent attaching of decorative ensembles and ornaments is repeated on the other exterior shutter within the at least one set to present a display system related to at least two different themes which are further aesthetically complimenting of one another.

There is still even further disclosed a method of improving the exterior appearance of a house having exterior shutters adjacent to windows in an easy to change fashion. A plurality of ornaments and/or other applicable embodiments, or any principles and/or applications thereof further related to the present invention are provided, each having selected regal or majestic like decorations, which collectively represent a regal or majestic theme. At least one ornament having a selected regal or majestic like decoration is attached to at least a portion of at least planar surface which may be on, or about the outer face of each of the exterior shutters, wherein the selected regal or majestic like decorations collectively represent a theme and further present a regal or majestic like display system related to the theme upon the exterior shutters 10 of the house. The ornaments are quickly and easily removed from the exterior shutters at a substantially later date or when desired, and may be further changed or replaced to display similar regal or majestic like themes for the exterior of the house.

There is further disclosed a method of changing the exterior appearance of a window having exterior shutters adjacent thereto. A plurality of ornaments and/or other applicable embodiments, or any principles and/or applications thereof further related to the present invention is provided having selected decorations, which collectively represent a theme. At least one ornament having a selected decoration is attached to at least a portion of at least planar surface which may be on, or about the outer face of one of the exterior shutters, at least a second ornament having the same selected decoration is attached to at least a portion of at least planar surface which may be on, or about the outer face of the other exterior shutter, wherein the selected decorations collectively represent a theme and a changeable display system related to the theme is presented. All of the at least ornaments are removed from the exterior shutters at a substantially later date, or when desired. The steps laid out herein are repeated as desired using different selected decorations, whereby a changeable exterior appearance for a window having exterior shutters adjacent thereto is provided.

There is still further disclosed a method of decorating the exterior appearance of a window having exterior shutters adjacent thereto. A plurality of ornaments and/or other applicable embodiments, or any principles and/or applications thereof further related to the present invention is provided having selected decorations, which collectively represent a theme. One ornament having a selected decoration is attached to at least a portion of at least planar surface, which may be on, or about the outer face of one of the exterior shutters. At least a second ornament having a different selected decoration is attached to at least a portion of at least planar surface, which may be on, or about the outer face of the same exterior shutter, wherein the selected decorations are directed to a theme. The attaching of the at least interchangeable ornaments having at least the same two selected decorations is repeated on at least a portion of at least planar surface which may be on, or about the outer face of the other shutter to present a display system related to the theme.

There is still even further disclosed a method of coordinating a thematic display for the exterior of a house having exterior shutters thereon. A plurality of ornaments and/or other applicable embodiments, or any principles and/or applications thereof further related to the present invention is provided in combination with at least a decorative house flag. The ornaments and at least decorative house flag each having selected decorations, which collectively represent a theme. The at least decorative house flag further has at least a predetermined shape and/or at least a portion of decorative surface thereof, and a pole. At least one ornament having a selected decoration is removably attached to at least a portion of at least planar surface, which may be on, or about the outer face of each of the exterior shutters of the house wherein the selected decorations collectively represent a theme, and a changeable display system is presented related to the theme. The at least decorative house flag having a pole and a selected decoration is mounted on the house or porch thereof, wherein the at least decorative house flag's selected decoration is directed to the theme that the ornaments are presenting in a changeable display system on the exterior shutters of the house, whereby a coordinated thematic display for the exterior of a house is presented.

There is last but not least, still even further disclosed a method of presenting a combination day and night display system on at least one set of exterior shutters adjacent to at least one window of a house wherein the daytime display may present an entirely different display than the nighttime display. A plurality of ornaments and/or other applicable embodiments, or any principles and/or applications thereof further related to the present invention is provided. The ornaments each having selected decorations, which collectively represent at least one theme, and at least two ornaments further having photoluminescent like qualities. One of the ornaments having a selected decoration and photoluminescent like qualities is attached to one of the exterior shutters. At least a second ornament having a selected decoration is attached to the same exterior shutter wherein the selected decorations are directed toward at least one theme. At least the two same like ornaments are attached to the other exterior shutter to present a display system related to the at least one theme. During the daytime, all at least four ornaments are visible and at nighttime only the at least two ornaments having photoluminescent like qualities are visible presenting a substantially different display. These and other objects of the present invention will become apparent from a reading of the following specifications taken in conjunction with the enclosed drawings.

### BRIEF DESCRIPTION OF THE DRAWINGS

FIG. 1 is a front view of a house having a changeable display system presented thereon.

FIG. 2 is an enlarged view of a portion of FIG. 1.

FIG. 3 is a front view showing an example of a pre-manufactured kit.

FIG. 4 is a front view showing an example of an ornament consisting of one decorative element having at least a predetermined shape and/ or at least a portion of decorative surface thereof, an inner face, and an outer face.

FIG. 5 is a cross-sectional view taken across the lines 5-5 of FIG. 4.

FIG. 6 is a front view showing another example of an ornament consisting of one decorative element having at least a predetermined shape and/or at least a portion of decorative surface thereof, an inner face, and an outer face, and further possessing photo-luminescent like qualities.

FIG. 7 is a front view showing yet another example of an ornament consisting of one decorative element having at least a predetermined shape and/ or at least a portion of decorative surface thereof, an inner face, and an outer face.

FIG. 8 is a cross-sectional view taken across the lines 8-8 of FIG. 7.

FIG. 9 is a front view showing still further another example of an ornament consisting of one decorative element having at least a predetermined shape and/or at least a portion of decorative surface thereof, an inner face, and an outer face, and is also still further an example of how the ornament may be shaped or formed to conform to at least a portion of decorative surface which may be on, or about the inner face and/or the outer face thereof.

FIG. 10 is a front view showing an example of how a plurality of decorative elements may be permanently attached together or assembled to make the ornament.

FIG. 11 is a slightly enlarged cross-sectional view taken across the lines 11-11 of FIG. 10 additionally showing an example of how the inner face of at least one decorative element may be permanently attached or assembled to the outer face of at least a second decorative element using attachment means such as, for example, adhesives, glues, epoxies, cements 132, or other attachment means known in the art.

FIG. 12 is a front view showing another example of how a plurality of decorative elements may be permanently attached together or assembled to make the ornament.

FIG. 13 is a cross-sectional view taken across the lines 13-13 of FIG. 12.

FIG. 14 is an enlarged view of a portion of FIG. 13 further showing another example of how a plurality of decorative elements may be permanently attached together or assembled to make the ornament using attachment means such as, for example, adhesives, glues, epoxies, cements, or other attachment means known in the art.

FIG. 15 is a front view showing an example of a plurality of decorative elements that may be permanently attached together or assembled to make the ornament, and also further shows an example of the versatility that is afforded the decorative elements, wherein the decorative elements may be made any desirable shape, form, color, etc.

FIG. 16 is a perspective view showing an assembled example of how the plurality of decorative elements previously shown in FIG. 15 may be attached together or assembled to make the ornament.

FIG. 17 is an enlarged cross-sectional view taken across the lines 17-17 of FIG. 16 showing an example, wherein some of the decorative elements which are visible from this angle or view, are further attached together or assembled with attachment means such as, for example, adhesives, glues, epoxies, cements, staples, or other attachment means known in the art.

FIGS. 18-20 show three different front view examples, which further show the versatile nature afforded the ornaments when permanently attaching or assembling a plurality of decorative elements together for the purpose of making the ornaments using attachment means such as, for example, permanent adhesives, glues, epoxies, cements, staples, or other attachment means known in the art.

FIGS. 21-22 show two front view examples, each showing of how a group of decorative elements may be permanently attached in a predetermined grouping on the outer face of at least one decorative element to present a single display or decorative ensemble. FIG. 22 further shows another example how photo-luminescent like qualities can be used in any application related to the present invention.

FIG. 23 is a front view showing an example of how the ornament shown in the example of FIG. 21 may have a plurality of decorative elements and decorative ensembles permanently attached to the outer face thereof further providing many variable options when making the ornament.

FIG. 24 is a front view showing an example of a decorative ensemble having at least a second similar like decorative ensemble layered on, or about the outer face thereof.

FIG. 25 is a front view showing yet another example of how different variable combinations of decorative elements and decorative ensembles may be permanently attached together to make the ornament.

FIG. 26 is a cross-sectional view taken across the lines 26-26 of FIG. 25.

FIG. 27 is a front view showing an example of an ornament, which may be removably attached to at least a portion of at least planar surface which may be on, or about the outer face of the exterior shutter.

FIG. 28 is cross-sectional view taken across the lines 28-28 of FIG. 27.

FIG. 29 is an enlarged view of a portion of FIG. 28 showing an example of the ornament removably attached to at least a portion of at least planar surface which may be on, or about the outer face or the exterior shutter with attachment means such as, for example, pressure sensitive adhesives.

FIG. 30 is another cross-sectional view taken across the lines 28-28 of FIG. 27

FIG. 31 is an enlarged view of a portion of FIG. 30 showing the ornament removably attached to at least a portion of at least planar surface which may be on, or about the outer face or the exterior shutter with attachment means such as, for example, double coated pressure sensitive tapes, strips, or pads.

FIG. 32 is yet another cross-sectional view taken across the lines 28-28 of FIG. 27.

FIG. 33 is an enlarged view of a portion of FIG. 32 showing the ornament removably attached to at least a portion of at least planar surface which may be on, or about the outer face or the exterior shutter with attachment means such as, for example, hook and loop, or similar like recloseable fasteners.

FIGS. 34-69 are a series of examples showing many different types of decorations which may be used.

FIGS. 34-38 are showing several examples of regal or majestic like decorations and the example shown in FIG. 38 is further showing the use of photo-luminescent like materials.

FIG. 39 is an example showing decorations, which may be perceived by a person to be regal or majestic like and/or nautical like in nature.

FIG. 40 is an example showing birthday decorations.

FIG. 41 is an example showing graduation decorations.

FIG. 42 is an example showing a family event decoration.

FIG. 43 is an example showing religious decorations.

FIG. 44 is an example showing Christmas decorations.

FIG. 45 is an example showing Easter decorations.

FIG. 46 is an example showing a patriotic decoration.

FIG. 47 is an example showing Thanksgiving decorations.

FIG. 48 is an example showing Halloween decorations.

FIG. 49 is an example showing a Valentine's Day decoration.

FIGS. 50-51 are showing examples of nautical decorations.

FIGS. 52-53 are showing examples of country decorations.

FIG. 54 is an example showing a marquee like decoration.

FIGS. 55-57 are several examples showing geometric decorations.

FIG. 58 is an example showing spring decorations.

FIG. 59 is an example showing summer decorations.

FIG. 60 is an example showing fall decorations.

FIG. 61 is an example showing winter decorations.

FIGS. 62-63 are several examples showing sports decorations.

FIG. 64 is an example showing an animated character decoration.

FIG. 65 is an example showing demographic decorations.

FIG. 66 is an example showing organizational decorations.

FIGS. 67-69 are several examples showing decorations, which are historical, cultural, and symbolic.

FIG. 70 is a front view showing an example of an ornament having at least one thematically complimenting ornament that is removably attached to at least a portion of at least planar surface which may be on, or about the outer face thereof.

FIGS. 71-73 are three front views showing examples of how at least one ornament may be removably attached to the outer face of another ornament to cover, conceal, and/or present a new decoration thereon. FIG. 73 further shows another example how photo-luminescent like materials may be used in any suitable application as related to the present invention.

FIG. 74 is a cross-sectional view taken across the lines 74-74 of FIG. 70.

FIG. 75 is an enlarged view of a portion of FIG. 74 showing the second ornament removably attached to at least a portion of at least planar surface which may be on, or about the outer face of the first ornament with attachment means such as, for example, pressure sensitive adhesives.

FIG. 76 is another cross-sectional view taken across the lines 74-74 of FIG. 70.

FIG. 77 is an enlarged view of a portion of FIG. 76 showing the at least a portion of at least planar surface which may be on, or about the inner face of the second ornament removably attached to at least a portion of at least planar surface which may be on, or about the outer face the first ornament with attachment means such as, for example, double coated pressure sensitive tapes, strips, or pads.

FIG. 78 is yet another cross-sectional view taken across the lines 74-74 of FIG. 70.

FIG. 79 is an enlarged view of a portion of FIG. 78 showing at least a portion of at least planar surface which may be on, or about the inner face of the second ornament removably attached to at least a portion of at least planar surface which may be on, or about the outer face of the first ornament with attachment means such as, for example, hook and loop, or similar like reclosable fasteners.

FIGS. 80-82 show three different front view examples, which further show the versatile nature afforded the ornaments when removably attaching and/or layering a plurality of ornaments together using attachment means such as, for example, pressure sensitive adhesives, double coated pressure sensitive tapes, strips, or pads, hook and loop, or similar like reclosable fasteners, or other attachment means known in the art.

FIGS. 83-84 show two front view examples, each showing of how a group of ornaments may removably attached in a predetermined grouping on the outer face of at least one ornament to present a single display or decorative ensemble. FIG. 84 further shows another example how photo-luminescent like qualities can be used in any application related to the present invention.

FIG. 85 is a front view showing an example of how the ornament shown in the example of FIG. 83, may have a plurality of ornaments and decorative ensembles removably attached to the outer face thereof.

FIG. 86 is a front view showing an example of a decorative ensemble having at least a second similar like decorative ensemble removably attached on, or about the outer face thereof.

FIG. 87 is a front view showing yet another example of how different variable combinations of ornaments and decorative ensembles may be removably attached together.

FIG. 88 is a cross-sectional view taken across the lines 88-88 of FIG. 87.

FIG. 89 is a front view showing an example of a house having exterior shutters adjacent the windows thereof, and a changeable display system which is comprised of a plurality of ornamental base mounts that are each further permanently attached to at least a portion of at least planar surface which may be on the outer face of the exterior shutters, each ornamental base mount further having at least one ornament which may be removably attached to at least a portion of at least planar surface on, or about the outer face thereof.

FIG. 90 is an enlarged view of a portion of FIG. 89.

FIG. 91 is a front view, showing an example of an enlarged view of one, of the exterior shutters previously shown on the exterior of the house in FIGS. 89-90, the exterior shutter further having ornamental base mounts attached to at least a portion of at least planar surface which may be on the outer face thereof, each ornamental base mount still further having at least one ornament removably attached to at least a portion of at least planar surface which may be on, or about the outer face thereof.

FIG. 92 is a cross-sectional view taken across the lines 92-92 of FIG. 91.

FIG. 93 is a front view showing an example of an ornamental base mount having at least one thematically complimenting ornament that is removably attached to at least a portion of at least planar surface which may be on, or about the outer face thereof.

FIGS. 94-96 are three front views showing examples of how at least One ornament may be at least removably attached to the outer face of the ornamental base mount to cover, conceal, and/or present a new decoration thereon.

FIG. 96 further shows another example how photo-luminescent like materials may be used in any suitable application as related to the present invention.

FIG. 97 is an enlarged view of a portion of FIG. 92 showing an example of how the ornamental base mount, or at least a portion of at least planar surface which may be on, or about the inner face thereof may be permanently attached to at least a portion of at least planar surface which may be on, or about the outer face of the exterior shutter with attachment means such as, for example, adhesives, glues, epoxies, or cements. FIG. 97 further shows an example of how at least one ornament, or at least a portion of at least planar surface which may be on, or about the inner face thereof may be removably attached to at least a portion of at least planar surface which may be on, or about the outer face of the ornamental base mount with attachment means such as, for example, pressure sensitive adhesives.

FIG. 98 is another enlarged view of a portion of FIG. 92 showing another example, wherein different removable means of attachment such as, for example, double coated pressure sensitive tapes, strips, or pads may be used to removably attach at least a portion of at least planar surface which may be on, or about the inner face of the ornament to at least a portion of at least planar surface which may be on, or about the outer face of the ornamental base mount.

FIG. 99 is yet another enlarged view of a portion of FIG. 92 showing still further an additional example, wherein different removable attachment means such as, for example, hook and loop, or similar like reclosable fasteners may be used to attach at least a portion of at least planar surface which may be on, or about the inner face of at least one ornament to at least a portion of at least planar surface which may be on, or about the outer face of the ornamental base mount.

FIGS. 100-102 show three different front view examples, which further show the versatile nature afforded the ornamental base mounts when removably attaching at least one and/or layering a plurality of ornaments together using attachment means such as, for example, pressure sensitive adhesives, double coated pressure sensitive tapes, strips, or pads, hook and loop, or similar like reclosable fasteners, or other attachment means known in the art.

FIGS. 103-104 show two front view examples, each showing of how a group of ornaments may be removably attached in a predetermined grouping on the outer face of the ornamental base mount to present a single display or decorative ensemble. FIG. 104 further shows another example how photo-luminescent like qualities can be used in any application related to the present invention.

FIG. 105 is a front view showing an example of how the ornamental base mount shown in the example of FIG. 103, may have a plurality of ornaments and decorative ensembles removably attached to the outer face thereof using attachment means such as, for example, pressure sensitive adhesives, double coated pressure sensitive tapes, strips, or pads, hook and loop, or similar like reclosable fasteners, or other attachment means known in the art.

FIG. 106 is a front view showing an example of a decorative ensemble, which may be removably attached to the outer face of the ornamental base mount, having at least a second similar like decorative ensemble removably attached on, or about the outer face thereof using attachment means such as, for example, pressure sensitive adhesives, double coated pressure sensitive tapes, strips, or pads, hook and loop, or similar like reclosable fasteners, or other attachment means known in the art.

FIG. 107 is a front view showing yet another example of how different variable combinations of ornaments and decorative ensembles may be removably attached together on, or about the outer face of the ornamental base mount using attachment means such as, for example, pressure sensitive adhesives, double coated pressure sensitive tapes, strips, or pads, hook and loop, or similar like reclosable fasteners, or other attachment means known in the art.

FIG. 108 is a cross-sectional view taken across the lines 108-108 of FIG. 107.

FIGS. 109-110 are two front views showing examples of decorative ensembles, which may be removably attached to at least a portion of at least planar surface, which may be on, or about the outer face of the exterior shutter.

FIG. 111 is an enlarged view of a portion of FIG. 110.

FIG. 112 is a cross-sectional view taken across the lines 112-112 of FIG. 111.

FIG. 113 is an enlarged view of a portion of FIG. 112 further showing an example of how the decorative ensemble may be removably attached to the exterior shutter with attachment means such as, for example, pressure sensitive adhesives.

FIGS. 114-117 are several front views, each showing an example of the decorative ensemble that was previously removably attached to the exterior shutter in FIGS. 110-113, and further shows examples how they may be afforded with a variety of combinations of ornaments and/or decorative ensembles which may be removably attached to at least a portion of at least planar surface which may be on, or about the outer face thereof with attachment means such as, for example pressure sensitive adhesives.

FIG. 118 is a cross-sectional view across the lines 118-118 of FIG. 117.

FIG. 119 is a front view of a portion of a house showing an example of how the house looks before ornaments are attached to the shutters thereof.

FIG. 120 is a front view of the same portion of house, as shown in FIG. 119, further having ornaments and decorative ensembles attached to the outer face of the exterior shutters thereof, whereby an improved appearance for the house is provided.

FIG. 121 is a front view of a portion of a house showing an example of how the at least ornaments may be used to present a message.

FIG. 122 is a front view showing an example of a permanent surface treatment for exterior shutters wherein, a glow in the dark display system is provided.

FIG. 123 is a front view showing an example of a permanent surface treatment for exterior shutters wherein, a coordinating thematic display system is presented.

FIG. 124 is a front view showing an example of a permanent surface treatment for exterior shutters wherein, at least two different yet complimenting themes comprised of at least ornaments are presented in a permanent fashion thereon in a display system.

FIG. 125 is a front view showing an example of a permanent surface treatment for exterior shutters wherein, at least two decorative ensembles, each having the same selected decoration, are permanently attached to the exterior shutters to present a display system.

FIG. 126 is a front view showing an example of a permanent surface treatment for exterior shutters wherein, at least four decorative ensembles, having at least two different selected decorations, which are related to the same theme, are further permanently attached to the exterior shutters to present a coordinating thematic display system.

FIG. 127 is a front view showing an example of a permanent surface treatment for exterior shutters wherein, at least two different yet complimenting themes comprised of at least decorative ensembles are presented on the shutters in a permanent fashion in a display system.

FIG. 128 is a front view showing an example of a permanent surface treatment for exterior shutters wherein, a combination of decorative ensembles and ornaments having different selected decorations that are related to one theme are presented on the shutters in a permanent fashion in a display system related to the theme.

FIG. 129 is a front view showing an example of a permanent surface treatment for exterior shutters wherein, a combination of decorative ensembles and ornaments having different selected decorations that are related to at least two different yet complimenting themes are presented on the shutters in a permanent fashion in a display system.

FIG. 130 is a front view of one of the shutters shown by example in FIG. 129.

FIG. 131 is an enlarged view of a portion of FIG. 130.

FIG. 132 is a cross-sectional view across the lines 132-132 of FIG. 131.

FIG. 133 is an enlarged view of a portion of FIG. 132 showing an example of how at least a portion of at least planar surface on, or about the inner face side of the decorative ensemble may be permanently attached to at least a portion of at least planar surface, which may be on, or about the outer face of the exterior shutter.

FIG. 134 is an enlarged view of a portion of FIG. 130.

FIG. 135 is a cross-sectional view across the lines 135-135 of FIG. 134.

FIG. 136 is an enlarged view of a portion of FIG. 135 showing an example of how at least a portion of at least planar surface on, or about the inner face side of the ornament may be permanently attached to at least a portion of at least planar surface, which may be on, or about the outer face of the exterior shutter.

FIG. 137 is a front view of a portion of a house showing an example of how the at least ornaments may be used to provide a changeable exterior appearance for a window having exterior shutters adjacent thereto.

FIG. 138 is a front view of a portion of a house showing an example of how the at last ornaments may be used to decorate the exterior of a window having exterior shutters adjacent thereto.

FIG. 139 is a front view of a portion of a house showing an example of how the at least ornaments may be used in combination with at least a decorative house flag, whereby presenting a coordinated thematic display for the exterior of a house or property.

FIG. 140 is a front view of a portion of a house showing an example of how the at least ornaments may be used to present a day and night display system.

### DESCRIPTION OF PREFERRED EMBODIMENTS

Although the present invention, with its many variables regarding embodiments, materials, and ways to make the invention will now be described with reference to the drawings, it is to be understood that such embodiments, materials, and ways to make the invention are by way of example only and merely illustrative of but a small number of the many possible embodiments, materials, and ways to make the invention which can represent applications of the principles of the present invention. Various modifications and changes obvious to one skilled in the art to which the present invention pertains are deemed to be within the spirit, scope and contemplation of the present invention as further defined in the appended claims.

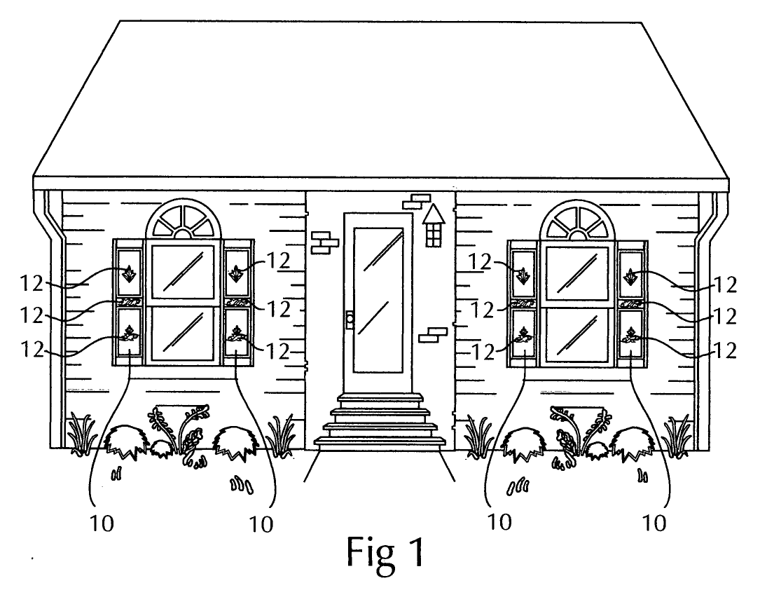

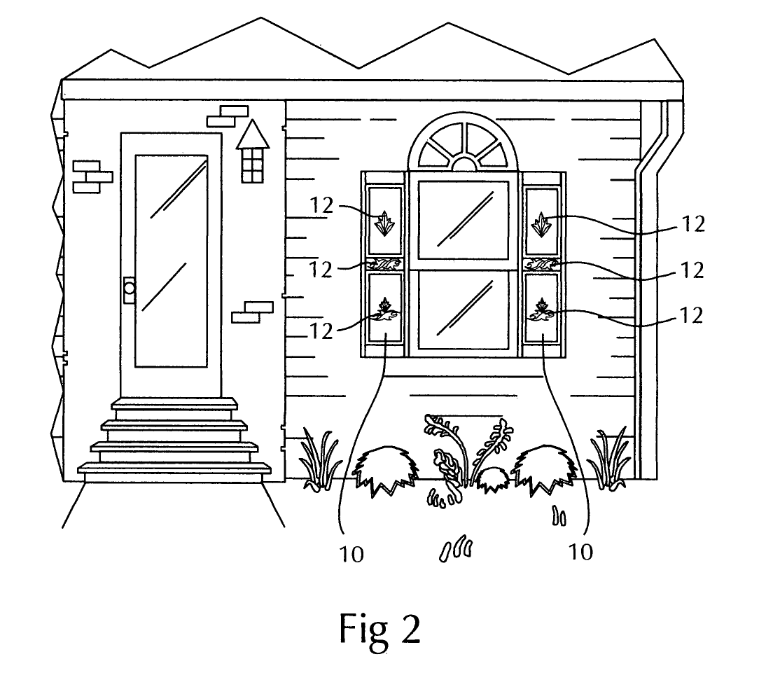

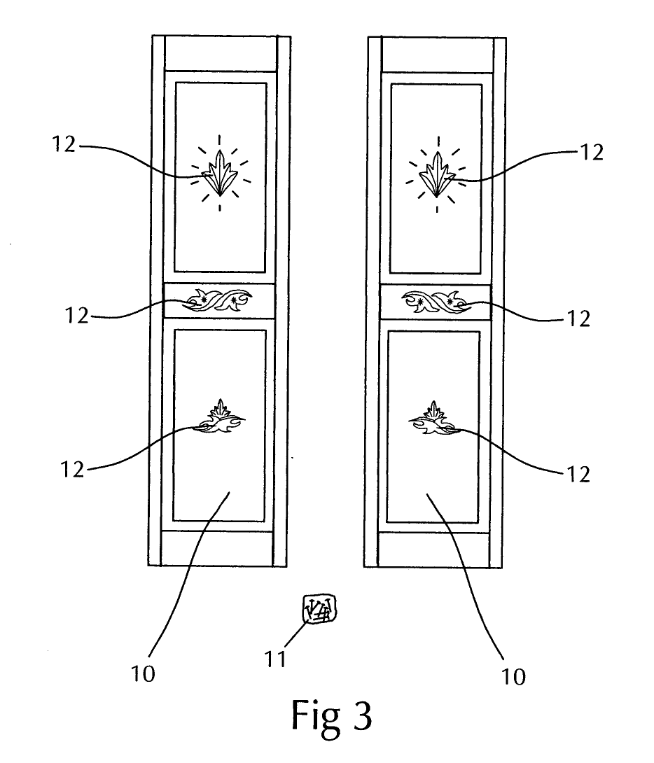

FIGS. 1-2 shows an example of how the exterior of a house, or a portion thereof may look after a changeable display system is furnished thereon. A plurality of exterior window shutters 10 is provided in combination with a plurality of ornaments 12 having selected decorations, which collectively represent a theme. The exterior shutters 10, in a manufacturing stage are each made of a suitable material such as, for example, plastic, wood, or other materials known to those skilled in the art, and further have an inner face, an outer face, side edges adjacent the inner face and the outer face, the inner face and outer face still further having at least portions of at least planar surface thereof, and at least one ornament 12 which may be removably attached to at least a portion of at least planar surface which may be on, or about the outer face thereof. The at least one ornament 12 may be made of at least one decorative element, which is further defined herein as at least a portion of suitable material having at least a predetermined shape and/or at least a portion of decorative surface thereof, an inner face, an outer face, and a structural body which is preferably substantially smaller in relation as compared to the height and width dimensions of the exterior shutter 10. The exterior shutters 10, each having at least one ornament 12 disposed thereon, are further disposed upon the exterior of the house adjacent to at least one window, wherein the exterior shutters 10 in combination with the ornaments 12 having selected decorations which collectively represent a theme, further cooperate in a collective fashion to present an instant display system related to the theme upon the exterior of the house which is easily changeable, whereby further projecting a visual thematic display outwardly from the house that may be seen at a substantial distance from the house by a person or persons. As shown in FIGS. 1-2, a regal or majestic like theme or motif is presented in which the at least interchangeable ornaments 12 of the present invention are presented in combination with the exterior shutters 10 on the exterior of the house, further providing a substantial improvement to the appearance thereof, and still further projecting a visual thematic regal or majestic like display outwardly from the house, which may be easily removed or changed as desired. The regal or majestic like theme may be quickly and easily removed as desired and similar matching decorations which are to be disclosed herein, may be used to improve and/or change the exterior appearance of the house for any, to be disclosed events, or any event which persons may desire. In this manner, the ornaments 12 can be changed as frequently as desired and can be coordinated in any fashion with the at least exterior shutters 10 to present the changeable display system for the exterior of the house. The exterior shutters 10, each having at least one ornament 12 thereon, may be paired in sets of at least two and sold as a kit or kits. FIG. 3 shows an example of at least one of the kits, which may be made in the manufacturing stage and further provided as a changeable display system as shown in FIGS. 1-2, by the likes of an exterior shutter 10 manufacturer and/or at least one product distributor therefore. The kits are comprised of at least one set of exterior shutters 10, the mounting hardware therefore, and at least one set and/or any possible variable combination of sets of ornaments 12, which may further be removably attached to the exterior shutter 10 with attachment means to be disclosed herein. Any suitable attachment means, generally known as shutter 10 hardware or mounting hardware may be provided within the kit and further used to attach the at least one set of exterior shutters 10 adjacent to the at least one window on the exterior of the house. Attachment means such as, for example, shutter spikes 11, may be provided within the kit and further used to attach the at least one set of exterior shutters 10 to the exterior of the house adjacent to the at least one window. These are by no means the only means of attaching exterior shutters 10 to the exterior of the house. Other mounting hardware such as, for example, screws, anchors, lags, clips or clamps, shutter hinges, bracket apparatuses, or similar like mounting hardware known in the art may alternately be provided within the kit, and further used to attach the at least one set of exterior shutters 10 to the exterior of the house adjacent to the at least one window. The at least one set and/or any possible variable combination of sets of ornaments 12 which may be provided within the kits may have selected decorations that may be related to one theme and/or several different themes. The kits are also afforded all the amenities that are to be disclosed herein and further to be related to the present invention, whereby the kits are afforded nearly endless possible presentation combinations which may even further include for example, thematically matched decorative house flags 20 and/or door mats 22. The kits may come in a variety of forms wherein the at least one set and/or any possible variable combination of sets of at least ornaments 12, and/or any other applicable embodiments, or any principles and/or applications thereof which may be further disclosed and related to the present invention, may also be provided separately and not attached to the at least one set of exterior shutters 10 within the kit, or separately in combination with the at least one set and/or any possible variable combination of sets of at least ornaments 12 and/or any other applicable embodiments, or any principles and/or applications thereof which may further be related to the present invention, which may be at least removably attached to the at least one set of exterior shutters 10 within the kit or kits.

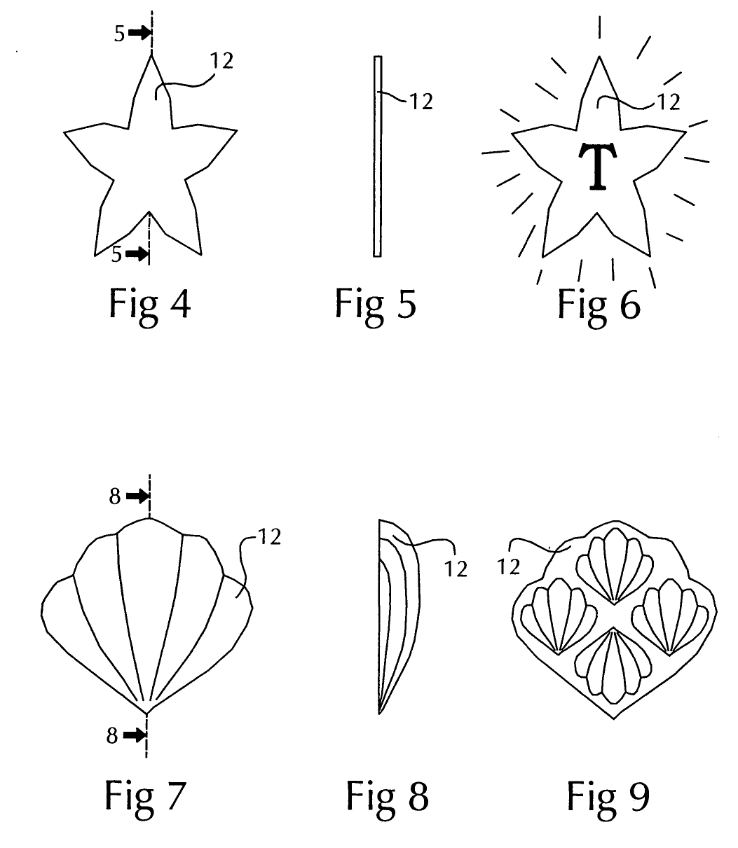

The ornaments 12 of the present invention each have a structural body that is preferably substantially smaller in relation as compared to the height and width dimensions of the exterior shutter 10. The ornaments 12 are each further made of at least one decorative element comprised of at least a portion of suitable material having at least a predetermined shape and/or at least a portion of decorative surface thereof, an inner face, and an outer face. FIGS. 4-9, show several examples of ornaments 12, each having at least one decorative element. The at least portion of decorative surface may be made on, or about the inner face and/or the outer face of the ornament 12. The inner face of the ornament 12 is oriented toward at least a portion of at least planar surface, which may be on, or about the outer face of the at least exterior shutter 10, and the outer face of the ornament 12 is oriented outwardly, away from the at least exterior shutter 10. FIG. 6 shows an example of the ornament 12, which is made of one decorative element and which may further possess photo-luminescent like qualities. FIG. 9, shows another example of how the ornament 12 may be shaped or formed to conform to the at least portion of decorative surface, which may be made on, or about the inner face and/or the outer face thereof.

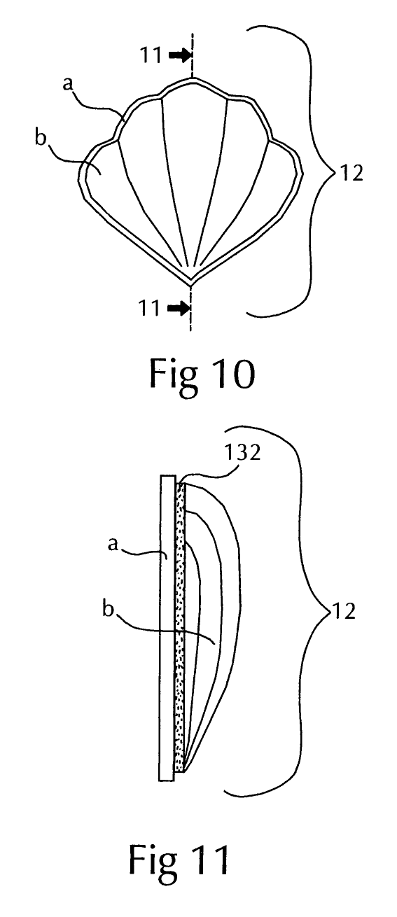

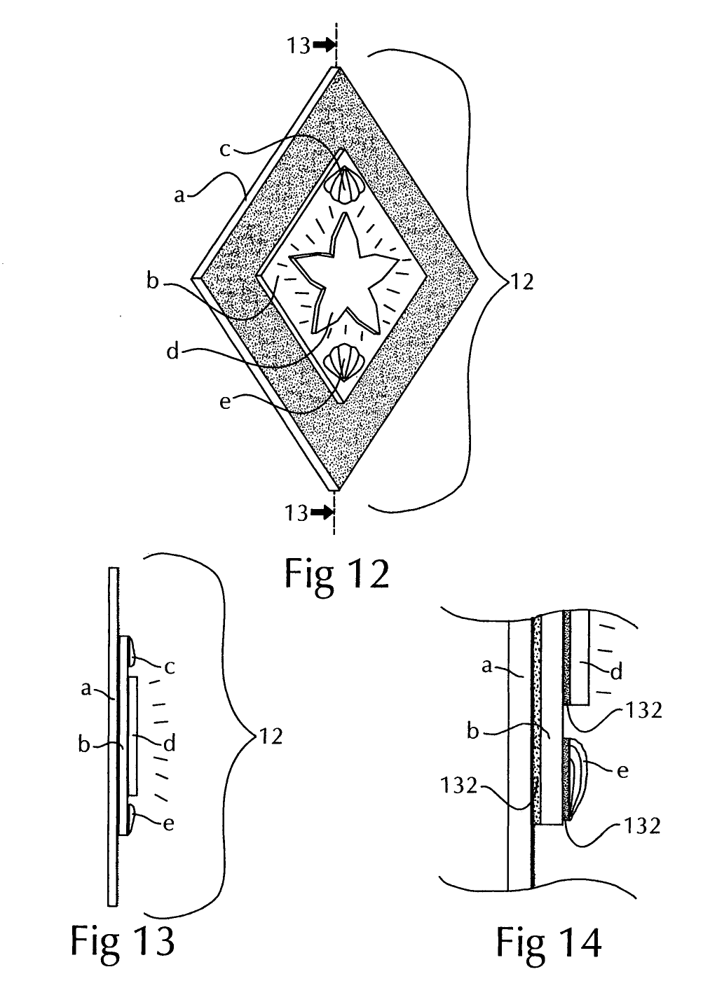

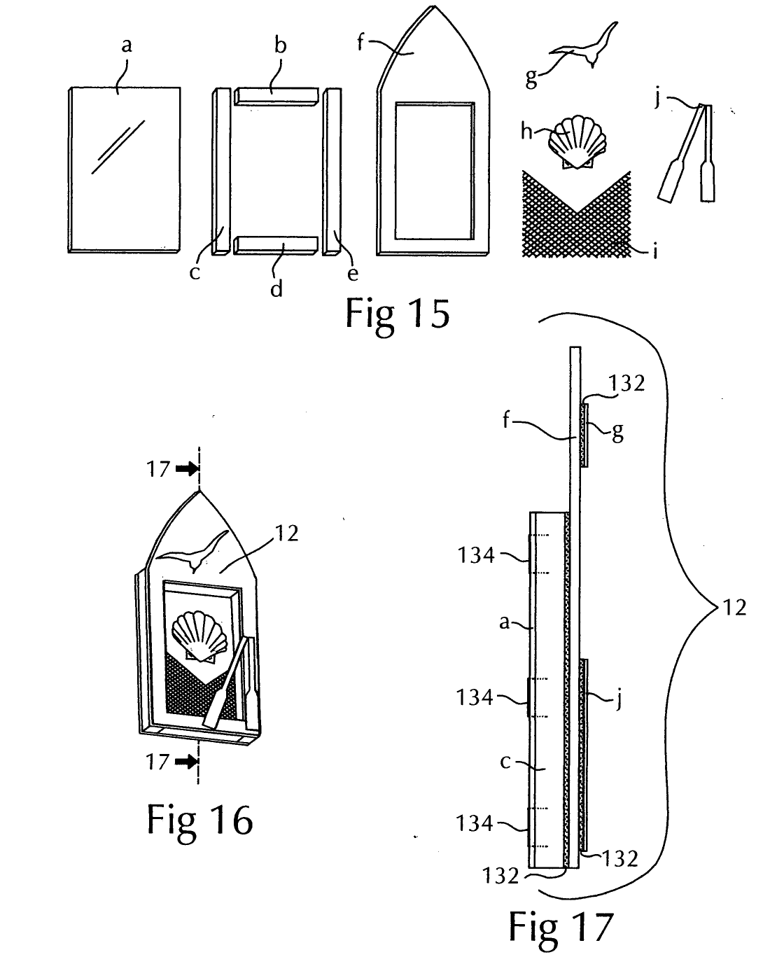

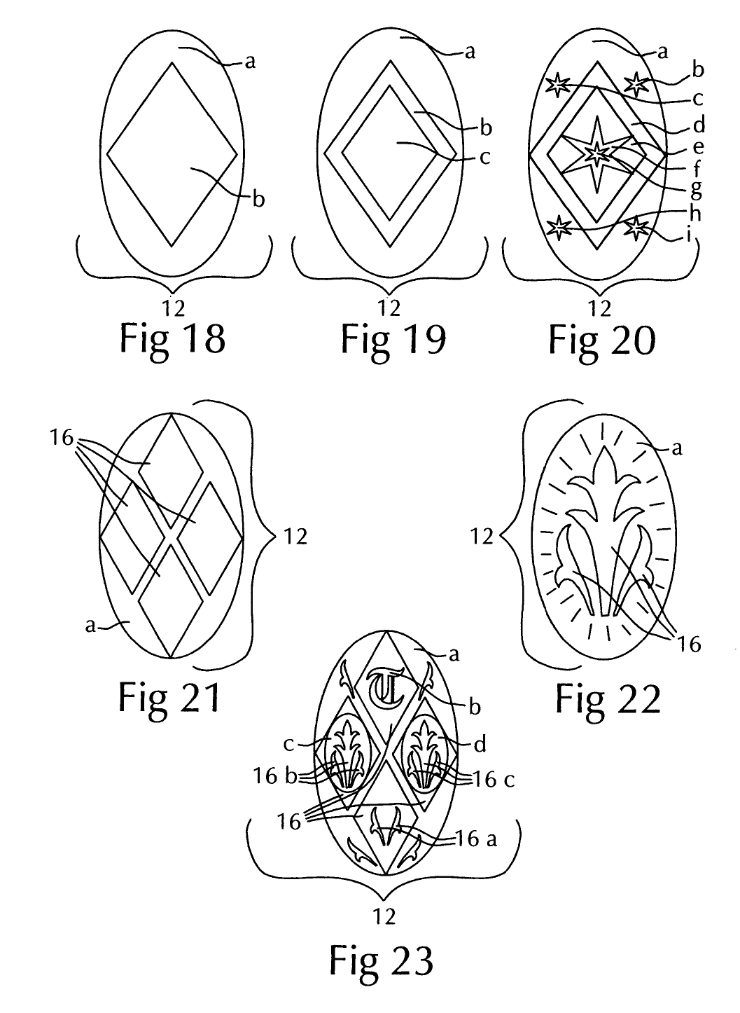

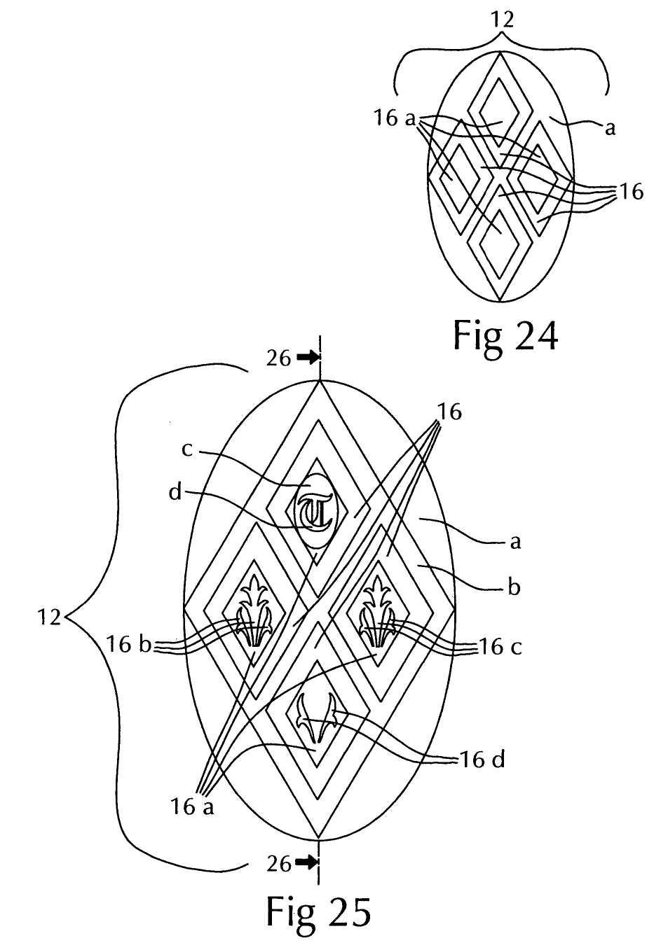

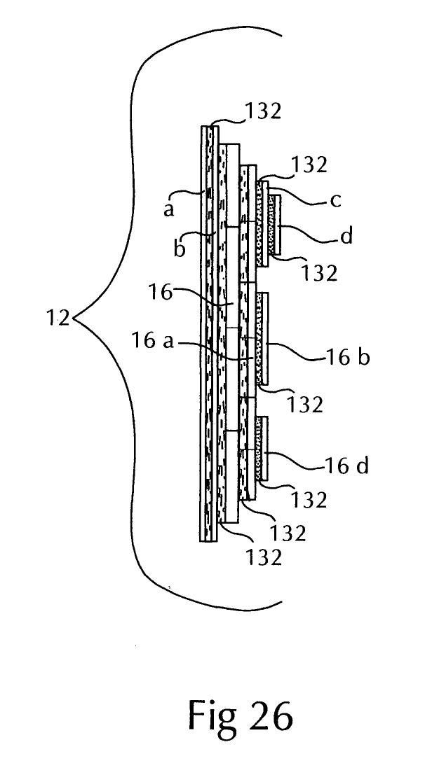

As shown in the examples of FIGS. 10-25, a plurality of decorative elements may also be permanently attached together or assembled to make the ornaments 12 by means known to those skilled in the art. Attachment means such as, for example, permanent adhesives, glues, epoxies, cements 132, or staples 134, may be used to permanently attach or assemble at least a portion of at least planar surface which may be on, or about at least one decorative element to at least a portion of at least planar surface which may be on, or about either the inner face, or the outer face of at least a second decorative element. These are by no means the only permanent attachment means, which may be used to permanently attach or assemble at least two decorative elements together for the purpose of making the ornaments 12. Alternately, attachment means such as, for example, screws or similar like fasteners, male connecters, male and female connecters, nails, rivets, wires, ties, hot melts, lamination, heating, stitching or sewing, soldering, welding, bonding, machine or industry processes known in the art, as well as other attachment means known to those skilled in the art, may also be used to permanently attach or assemble at least two decorative elements together for the purpose of making the ornament 12. FIGS. 10-20 show many examples of the flexible versatility that the ornaments 12 are afforded regarding the nearly endless combinations which may be made when permanently attaching or assembling a plurality of decorative elements together in any desirable manor, for the purpose of making the ornaments 12. FIGS. 10-11 show an example, wherein at least a portion of at least planar surface which may be on, or about at least one decorative element, may be permanently attached or assembled on at least a portion of at least planar surface that may be on, or about either the inner face, or the outer face of at least a second decorative element for the purpose of making the ornament 12 as referenced by letters (a-b) in FIGS. 10-11, using attachment means disclosed above, herein, any suitable combinations thereof and/or other attachment means known in the art. As the examples show in FIGS. 12-17, a plurality of decorative elements may be permanently attached or assembled together in any desirable fashion to make the ornament 12 using attachment means disclosed above, herein, any suitable combinations thereof and/or other attachment means known in the art. The decorative elements that are to be permanently attached or assembled together to make the ornament 12 may be combinations of at least portions of the same types of materials or substantially different types of materials, each further having at least a predetermined shape and/or at least a portion of decorative surface thereof, an inner face, an outer face and a structural body which is preferably substantially smaller in relation as compared to the height and width dimensions of the exterior shutter 10. Further shown in FIGS. 12-14, is an example of how at least a portion of the ornaments 12 may be made in any desirable fashion using any suitable materials which may be the same and/or substantially different. The material or materials, decorative surfaces, coatings etc, to be disclosed shortly hereafter, which may be used to make, decorate or coat the ornaments 12 may also posses photo-luminescent like qualities as further shown in FIGS. 12-14. Shown in FIGS. 15-17, is yet another example of how flexible the designing options may be when permanently attaching a plurality of decorative elements together for the purpose of making the ornaments 12. FIGS. 18-20 show three different front view examples, which further show the versatile nature afforded the ornaments 12 when permanently attaching or assembling at least one and/or a plurality of decorative elements to at least a portion of at least planar surface that may be on, or about the outer face of at least one decorative element and/or a plurality of decorative elements which may be consecutively layered on, or about at least a portion of at least planar surface which may be on the outer face of at least one decorative element for the purpose of making the ornament 12. Any suitable decorative elements that are to be permanently attached or assembled together using attachment means such as, for example, permanent adhesives, glues, epoxies, cements 132, staples 134, other attachment means previously disclosed herein, any suitable combination thereof, or other attachment means known in the art to make the ornaments 12 as referenced by the letters (a-b) in FIGS. 10-11, (a-e) in FIGS. 12-14, (a-j) in FIGS. 15 and 17, (a-b) in FIG. 18, (a-c) in FIG. 19, and (a-i) in FIG. 20, may generally as shown in the examples of FIGS. 10-20, each be made into any desirable at least shapes or forms using any suitable materials, and may each further have any desirable at least portion of decorative surface thereof, whereby affording nearly endless combinations when designing and further permanently attaching or assembling the plurality of decorative elements together for the purpose of making the ornament 12. FIGS. 21 and 22, show two front view examples of how a plurality of decorative elements may be permanently attached in a predetermined grouping on, or about at least a portion of at least planar surface which may be on the outer face of at least one decorative element, each decorative element within the grouping is positioned in a close proximity in relation to the other decorative elements within the grouping, wherein all of the decorative element's at least predetermined shapes and/or at least a portions of decorative surface thereof further cooperate collectively as a group to present a single display or decorative ensemble 16, which as shown by example in FIGS. 21 and 22, may be permanently attached on, or about at least a portion of at least planar surface which may be on the outer face of at least one decorative element for the purpose of making the ornament 12 using attachment means such as, for example, permanent adhesives, glues, epoxies, cements 132, staples 134, other attachment means previously disclosed herein, any suitable combination thereof, or other attachment means known in the art. Further shown in FIGS. 22, is another example of how photo-luminescence may be used in any desirable application, which may be related to the present invention. The decorative ensemble 16 is generally substantially small in nature wherein the width in most circumstances will be no more than eight inches wide, and the height of the decorative ensemble 16 is generally no larger than twelve inches tall. Although modifications may be made for enlargement, the general structure of the decorative ensemble 16 will preferably range from considerably smaller than the width and height parameters disclosed above, to substantially smaller than the width and height parameters disclosed above. The decorative ensemble 16 which may be permanently attached on, or about at least a portion of at least planar surface that may be on the outer face of at least one decorative element for the purpose of making the ornament 12, may be comprised of two or more decorative elements. FIG. 23 further shows an example of how the decorative ensemble 16 shown in FIG. 21, which may be an integral part of the ornament 12 as shown in FIG. 21, may further be afforded with at least one decorative element as represented by (b) in FIG. 23 and/or at least one decorative ensemble 16a, each of which may additionally be permanently attached on, or about at least a portion of at least planar surface which may be on the outer face of at least one of the decorative elements which further collectively represent the decorative ensemble 16 in FIG. 23 using attachment means previously disclosed above, herein, any suitable combination thereof, or other attachment means known in the art. FIG. 23 further shows an example of how a plurality of decorative ensembles 16, 16a, 16b, 16c and a plurality of decorative elements as referenced by (a, b, c, and d), may be permanently attached or assembled, using attachment means previously disclosed above, herein, any suitable combination thereof, or other attachment means known in the art, on at least a portion of at least planar surface which may be on, or about the outer face of at least one decorative element in any desirable fashion including the layering thereof, and still further providing many obvious variable alternatives when making the ornament 12. FIG. 24, still even further shows an example of how the decorative ensemble 16 shown in FIG. 21, which may be made an integral part of the ornament 12 as shown in FIG. 21, may further have at least a second, at least similar like decorative ensemble 16 permanently attached on, or about the outer face thereof using attachment means previously disclosed above, herein, any suitable combination thereof, or other attachment means known in the art. FIGS. 25-26 shows yet another example of how different variable combinations of decorative elements as referenced by (a, b, c, and d), and decorative ensembles 16, 16a, 16b, 16c, and 16d, may be permanently attached together, using attachment means such as, for example, permanent adhesives, glues, epoxies, cements 132, other attachment means previously disclosed herein, any suitable combination thereof, or other attachment means known in the art, to make the ornament 12.

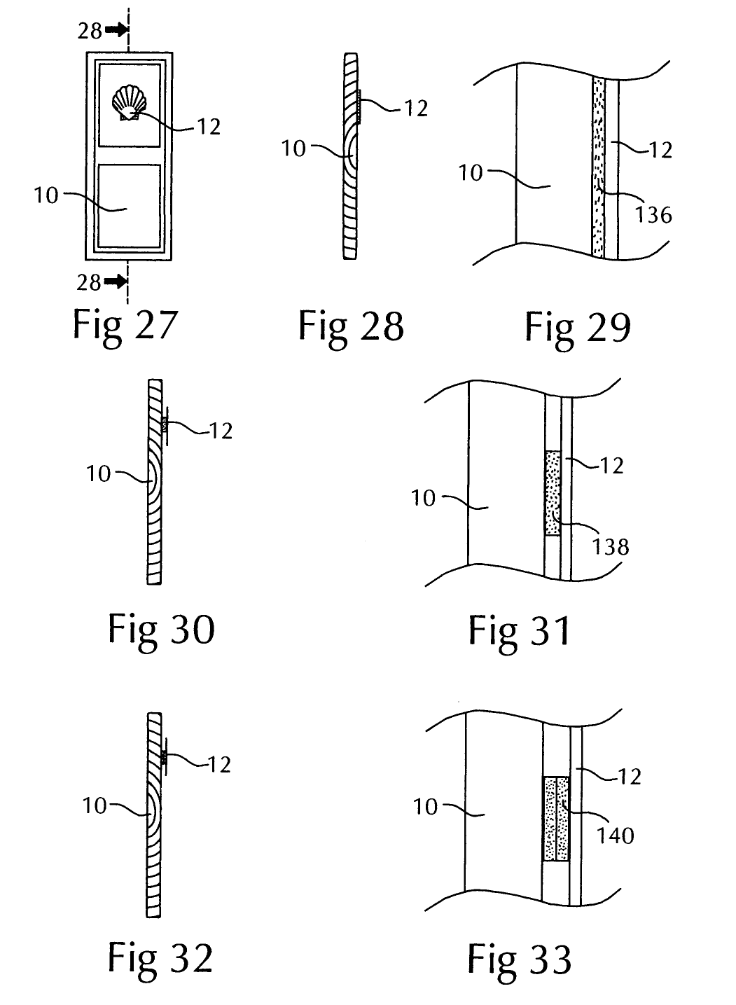

The ornaments 12 may be made of any suitable material or combinations of any suitable materials such as, for example, plastic, wood, or metal. These are by no means the only materials, which can be used to make the ornaments 12. Other materials such as, for example, resin, rubber, foil, mylar, foam, fabric, screen, elastic, cork, glass, tile, fiberglass, synthetic materials, or from materials made by nature such as, for example, sticks or twigs, tweed, straw, tree bark, grass, pine cones, pebbles or stones, gems, clay, marble, sea shells, sand dollars, starfish, or other similar like materials that may be made by nature and/or man, or any suitable combinations thereof may alternately be used to make the ornaments 12. Any suitable materials, or combinations thereof known to persons skilled in the art may also alternately be used to make the ornaments 12. The ornaments 12 may be flexible, semi-flexible, semi-rigid, rigid, or any desirable combinations thereof. As shown in an example of the preferred embodiment in FIGS. 27-29, the ornaments 12 are preferably a thin flexible or semi-flexible sheet or film like material having releasable pressure sensitive adhesive 136 on, or about at least a portion of surface which may be on the inner face side thereof, but not specifically limited thereto. The ornaments 12 may be transparent or opaque, and may be in a variety of colors. Any suitable at least portion of material and/or the at least portion of decorative surface thereof which may be related to the present invention, may further provide a source of photo-luminescence. Photo-luminescent materials have been well known in the art for many years. Zinc sulfide/copper based pigments which are a phosphorescent powder like compound may be mixed into a variety of materials such as, for example, paint, ink, plastic, ceramic, rubber and films etc., for the purpose of making glow-in-the-dark materials. The phosphorescent pigments convert absorbed light energy into a visible light energy. The re-emitted light during excitation is called “Fluorescence”. The re-emitted light energy after the light excitation source is removed is called glow-in-the-dark/“Phosphorescence”. The long afterglow of phosphorescence is called “Photo-luminescence”. Recently, an advanced photoluminescent material has been developed. The new phosphorescent pigment powders are a new type of long persistence phosphorescent pigment of alkaline earth aluminate activated by rare earth ions. The main characteristic of this material, which is referred to as strontium aluminate, is the particular structure of its crystal with the strong capacity of absorbing, storing, and emitting light. The strontium aluminate pigments have a longer charge or activation time as compared with the traditional zinc sulfide/copper based pigments and the two compounds may be mixed together to shorten the activation time of the strontium aluminate pigments. Although having a longer activation time, the strontium aluminate pigments have valuable advantages over the zinc sulfide/copper based pigments such as, at least ten times the afterglow properties as compared to the zinc sulfide/copper based pigments and an increase in luminescence. The luminous powders such as strontium aluminte and/or zinc sulfide/copper based pigments can be mixed in combination with other materials during the manufacture thereof, for providing such materials with photoluminescent like qualities. Materials such as, for example, paint, ink, plastic, ceramic, rubber and films etc., may be made in master batches. Each master batch may have a luminous powder content mixed therein, which may generally range from 5 to 20% of the total volume of the master batch. The percentage of luminous powder content and/or the particle size of the luminous powder may be increased to desirable levels when mixing a master batch to elevate the brightness and length of afterglow afforded the material within the batch. Coloring pigments may also be added to the master batch, but only limited amounts of colored pigment may be added so as not to cover the phosphorescent pigments inhibiting them from absorbing light energy. The material may then be made into various articles, which may be related to the present invention by cast, extrusion, coating, printing, or films by lamination, or by other means known to those skilled in the art. The strontium aluminate pigments are the preferred choice as a source of photo-luminescence that may be used in any desirable fashion and further applied to any of the principles and/or applications thereof which may further be related to the present invention as described herein. Alternately the zinc sulfide and/or any combination of the above may be used in any desirable fashion to provide a source of photo-luminescence which may be further applied to any of the principles and/or applications thereof which may further be related to the present invention as described herein.

The ornaments 12 may be made of natural and/or man made materials which exhibit a superior ability to withstand substantial UV exposure from the sun, high temperatures, low temperatures, high winds, ice, sleet, freezing rain, rain, humidity, or any similar extreme weather conditions or combinations thereof. The ornaments 12 may be made of natural and/or man made materials, that may be protected as later disclosed, which do not display resilient or durable qualities when exposed to durations of harsh outdoor conditions, or may further be made of a combination of materials some of which may fare better than others in variable climates and conditions.

The ornament's 12 predetermined shape may be naturally made by nature, or may be made by any suitable means, or any combinations of any suitable means such as, for example, sheeting, cutting, laminating, molding, casting or extruding. These are by no means the only means, or combinations thereof, which can be used to make the predetermined shape of the ornaments 12. Other means which may alternately be used to make the ornament's 12 predetermined shape may be means such as, for example, layering, heating, burning, thermo-forming, warping, shaping, stamping, embossing, punching, fraying, stripping, chipping, sawing, sanding, carving, grinding, routing, milling, pressing, crushing, compressing, weaving, embroidering, gathering, stuffing, sewing, bending, folding, or other similar like means known to those skilled in the art. The ornament's 12 predetermined shape may be any desirable shape such as, for example, a geometric shape or pattern, a shape that is considered a work of art, or any shape which is recognizable by a human being including letters, symbols, natural shapes made by nature, or any other shapes known in the art.

The at least portion of decorative surface, which may be made on, or about the inner face and/or the outer face of the ornament 12 may be made by any suitable means or combinations thereof such as, for example, printing, painting, or laminating. These are by no means the only means for decorating at least portion of at least planar surface, which may be on, or about the inner face and/or the outer face of the ornament 12. Other means for alternately decorating the at least portion of decorative surface, which may be made on, or about the inner face and/or the outer face of the ornament 12 may be for example, dying, staining, glazing, stamping, punching, drawing, coloring, engraving, etching, pressing, heating, layering, bending, creasing, gathering, cutting, sewing, weaving, embroidering, or other similar like means known to those skilled in the art. In addition, the ornaments 12 may be coated or covered with any suitable decorative and/or protective coatings or coverings such as, for example, plastic, paint, urethane, a water proof coating, a photoluminescent coating, a synthetic coating, or other similar like coatings or coverings known in the art which may provide any suitable decorative surface and/or protective barrier which may further decorate and/or protect the ornaments 12, or at least a portion thereof from the harsh outdoor elements. The decorative and/or protective surface coatings or coverings for the ornaments 12, and/or the materials from which the ornaments 12 may be made, may contain any suitable decorative additives known to those skilled in the art such as, for example, reflectives, metallics, translucents, or other additives known in the art which may further provide any desirable aesthetic enhancement for a surface which may be on, or about the inner face and/or the outer face of the ornaments 12. Any suitable decorative and/or protective coating or covering may be on, or about at least a portion of surface which may be on, or about the ornament 12, or may entirely coat or cover all surfaces which may be on, or about the ornament 12. Other decorative and/or protective coatings or coverings known in the art may also be used to decorate and/or protect the ornaments 12 or at least a portion thereof.

The at least portion of decorative surface which may be on, or about the ornament 12 may be transparent or opaque, and may be in a variety of colors, which may each further be capable of changing colors depending upon the angle of light thereon, or may glow in the dark and/or may be any desirable combination thereof.

Considering the fact that the ornaments 12 may be made many different ways, out of many different materials or combinations of materials which may be shaped or formed to any desirable shape or form, and may further have any desirable at least portion of decorative surface thereof, the ornaments 12 may therefore as a result, be provided with many different variable surface textures such as, for example, smooth, glossy, rough, grooved, raised, sculpted, stucco, matte, any suitable combination thereof, or other surface textures known in the art.

The ornament 12 may have at least a portion of decorative surface thereof, which may be a holographic image, or similar 3-d like images known to those skilled in the art.

The ornament 12 may be removably attached to at least a portion of at least planar surface, which may be on, or about the outer face the exterior shutter 10, by any suitable means known to persons skilled in the art. As shown in most simplistic form for the sake of clarity in FIGS. 27-33, the attachment means may be, for example, pressure-sensitive adhesives 136, double coated pressure-sensitive tapes, strips, pads or the like 138, hook and loop or similar types of reclosable fasteners 140 on at least a portion of at least planar surface which may be on, or about the inner face of the ornament 12 and on at least a portion of at least planar surface which may be on, or about the outer face of the exterior shutter 10. These are by no means the only removable attachment means that may be used to removably attach the ornament 12 to at least a portion of at least planar surface which may be on, or about the outer face of the exterior shutter 10. Other attachment means such as, for example, static cling, water-washable tacky elastomer, adhesive tabs, aerosol adhesives, suction cups or similar like suction cup devices, clamp like members or devices, male and female connecters, snaps, pins and pegs, clasps, brackets, channels, bars and grooves, friction fit devices, or other at least removable attachment means known to those skilled in the art may alternately be used to removably attach the ornament 12 to at least a portion of at least planar surface which may be on, or about the outer face of the exterior shutter 10. Any form of adhesives disclosed herein, or known in the art which may be used to attach at least a portion of at least planar surface which may be on, or about the inner face of the ornaments 12 to at least a portion of at least planar surface which may be on, or about the outer face of the exterior shutter 10, may further have substantially thin, protective backing sheets that cover and protect the adhesives until usage. The protective backing sheets may be slit for ease of removal.

The attachment means disclosed herein, any suitable combination thereof, or other attachment means known in the art which may be used to removably attach at least a portion of at least planar surface which may be on, or about the inner face of the ornaments 12 to at least a portion of at least planar surface which may be on, or about the outer face of the exterior shutter 10, may at least be disposed on at least a portion of at least planar surface which may be on, or about the inner face of the ornaments 12 and on at least a portion of at least planar surface which may be on, or about the outer face of the exterior shutter 10, or may be disposed on at least two, or more portions of at least planar surface which may be on, or about the inner face of the ornaments 12 and on at least two or more portions of at least planar surface which may be on, or about the outer face of the exterior shutter 10, or may be disposed on the entire inner face of the ornament 12 and on at least a portion of at least planar surface which may be on, or about the outer face of the exterior shutter 10 to provide a most secure attachment. If the ornament 12 is flexible or semi-flexible having pressure-sensitive adhesive 136 on at least a portion of at least planar surface which may be on, or about the inner face thereof, the ornament 12 may be disposed tautly over at least one, at least portion of at least planar surface which may be on, or about the outer face of the exterior shutter 10, or may be disposed tautly over at least a portion of at least one, at least planar surface in combination with one or more of the following; ledges, ridges, creases, recesses, or slatted portions, whereby the ornament 12 may conform only slightly, where necessary to adhere on, or about any suitable at least portion, or portions of surface and/or any suitable combinations thereof which may be on, or about the outer face of the at least exterior shutter 10. If the ornament 12 is flexible or semi-flexible having at least pressure-sensitive adhesive 136 on at least a portion of at least planar surface on, or about the inner face thereof, the ornament 12 may also be adapted wherein as much as possible to form fit or conform in a snug fashion to any of the previously disclosed outer face exterior shutter 10 surfaces or any suitable surface combinations thereof.

The ornament 12, as well as any form of releasable adhesive means disclosed herein, or known in the art which may be used to removably attach the ornament 12 on at least a portion of at least planar surface which may be on, or about the outer face of the exterior shutter 10 as shown by the example of the preferred embodiment in FIGS. 27-29, may be repositionable, removable, or disposable.

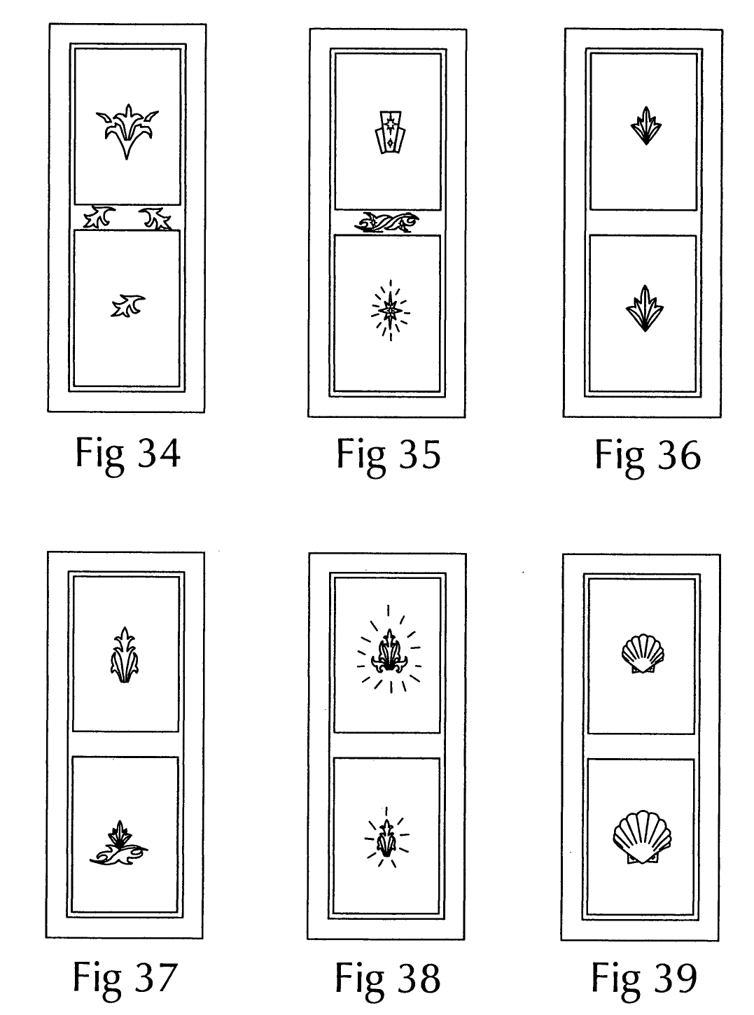

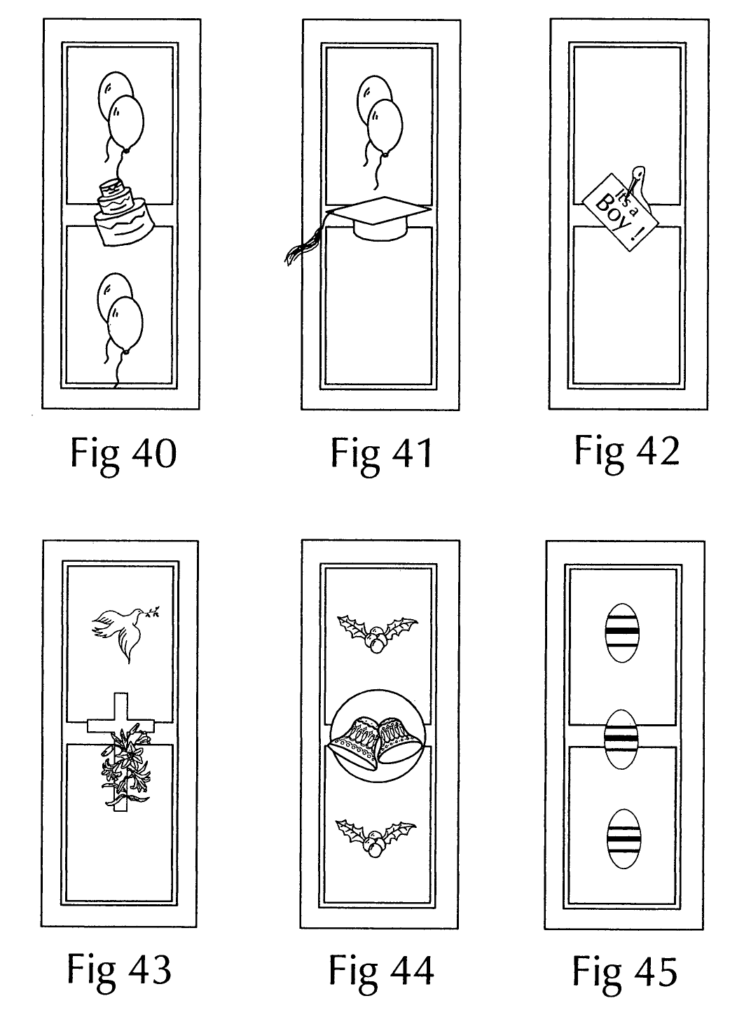

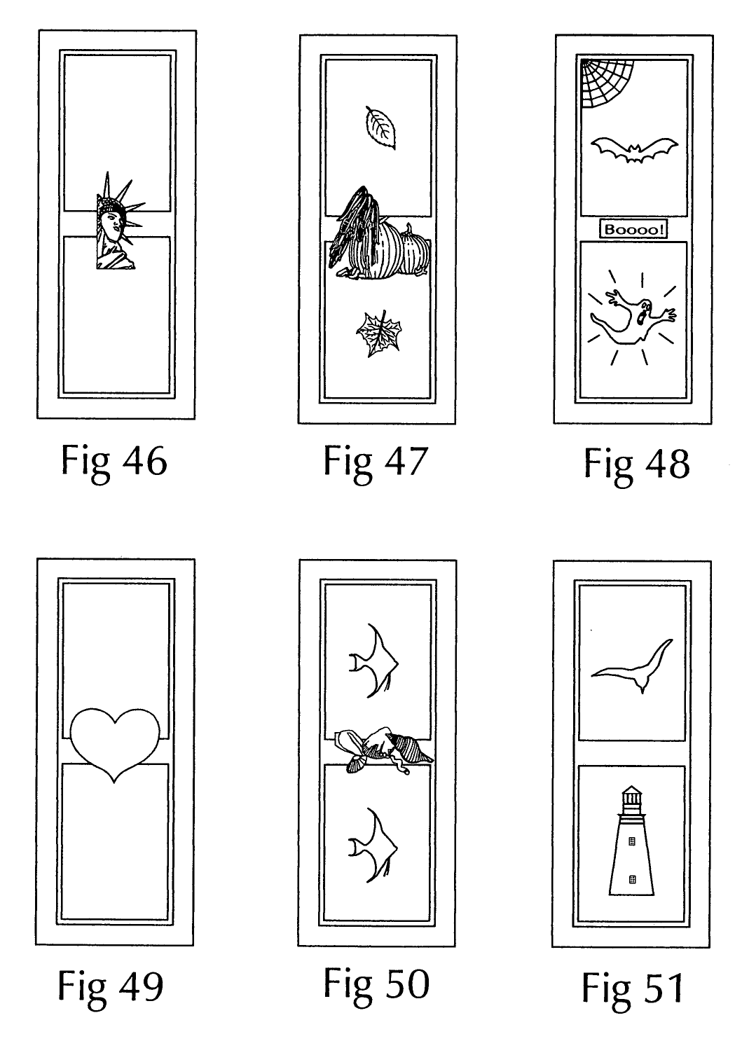

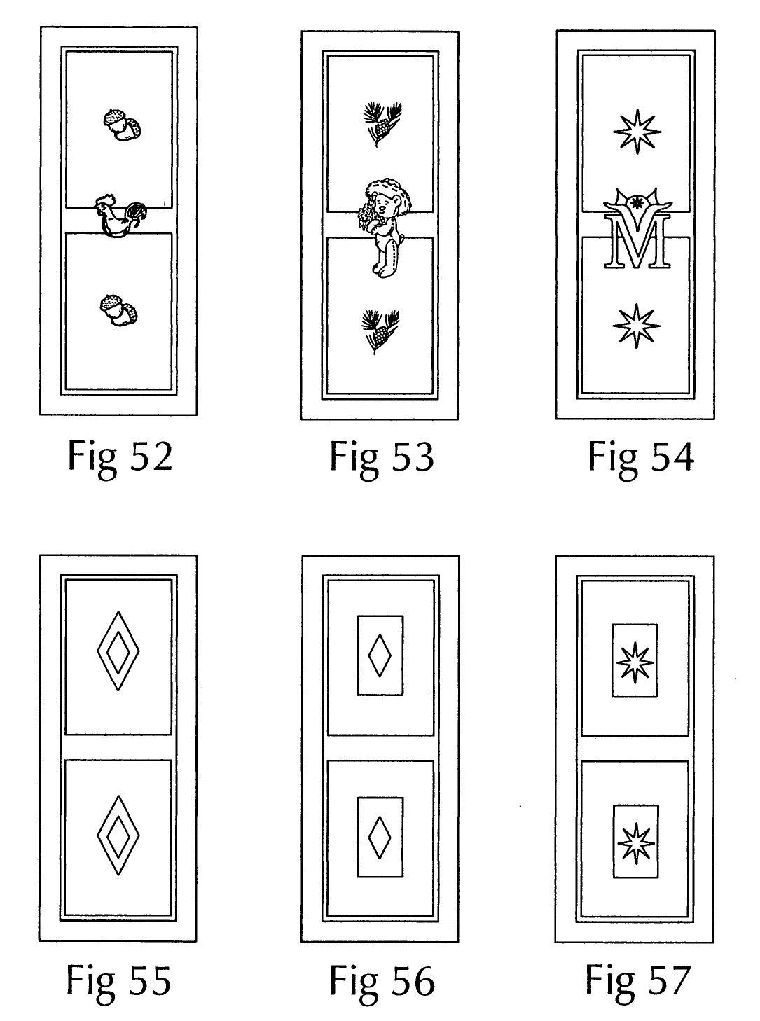

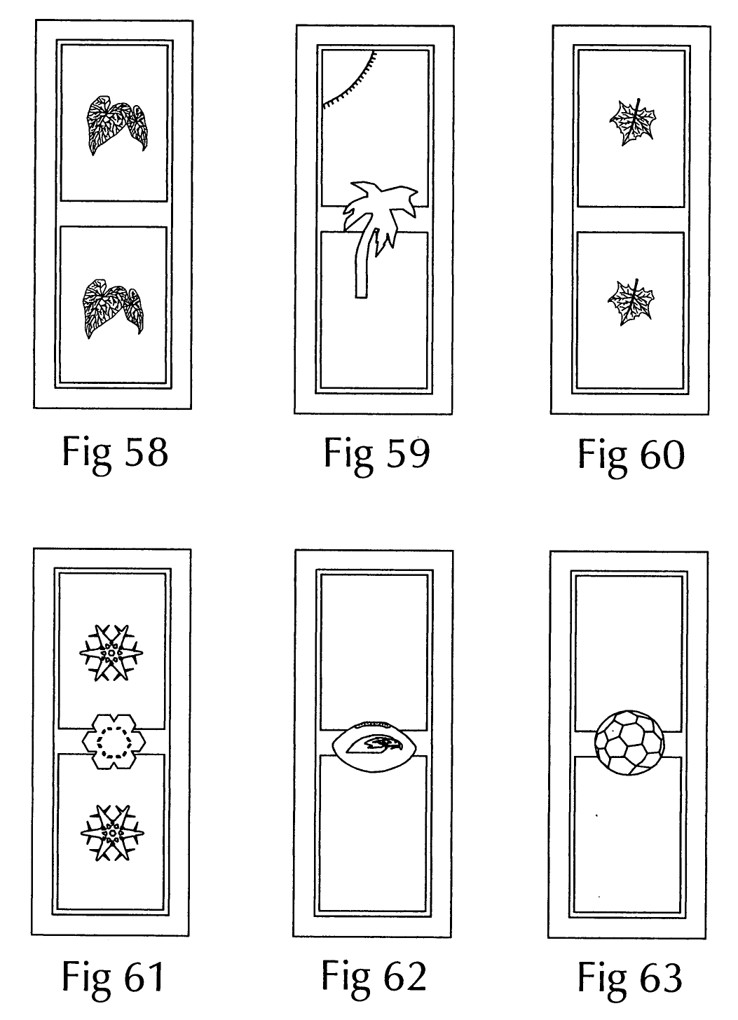

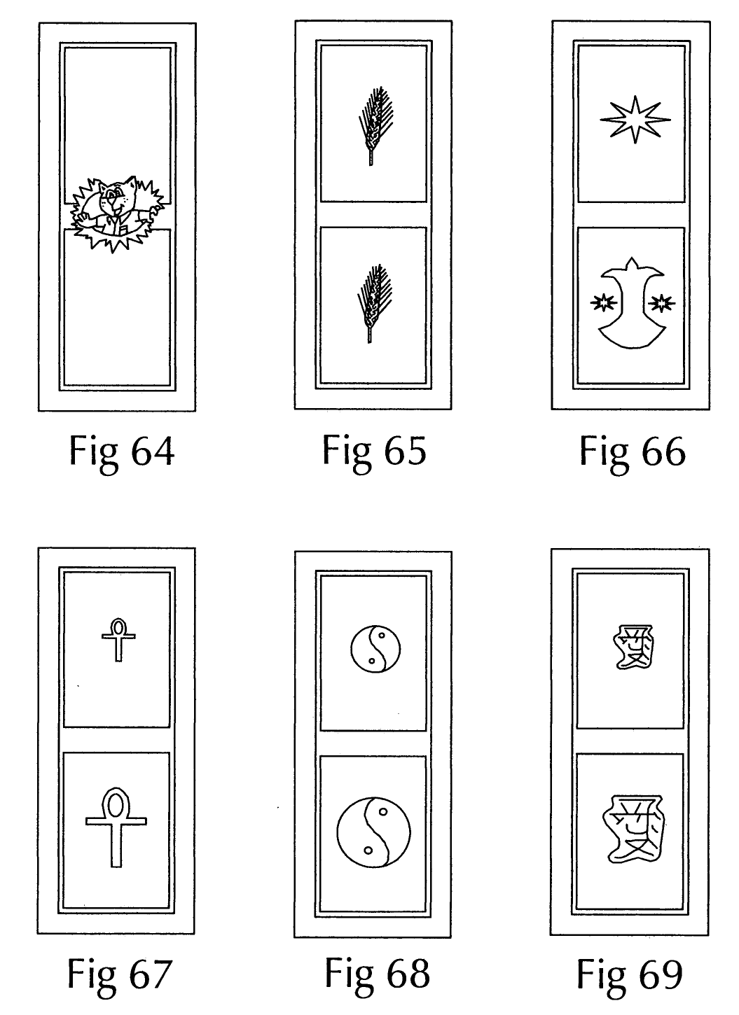

The nature and motif of the exterior shutter 10 decorations may be whatever is desired to customize the house (FIGS. 34-69). The decoration may be designed to change or improve the overall appearance of the house, affording it with a new regal or majestic like appearance. The decoration may be designed to decorate the appearance of the house for a family event such as a birthday, graduation or birth of a child. The decoration may be directed to religious themes such as expressions of faith, Christmas, or Easter greetings. Patriotic themes such as the Statue of Liberty can be displayed. Public holidays such as Thanksgiving, Halloween, and Valentines Day are also topics for the decorations. For everyday decoration, popular themes such as nautical themes and country themes may be the topic of display. Marques designs, artwork, or geometric shapes and patterns may be the subject of the decorations. Seasonal themes for spring, summer autumn and winter could be the subject of the decorations. The theme may be sporting events, animated characters, demographic and regional subjects, organizational, historical, cultural, or symbolic.

These are some of the subject matter, which are unlimited and may be what ever a person wishes to customize the exterior of the house.

The ornaments 12 for exterior shutters 10 are simply and rapidly mounted on, or dismounted, from the at least exterior shutter 10 without the use of tools.

The ornaments 12 for exterior shutters 10 may be replaced with a different ornament 12 whenever desired. The theme displayed on the exterior shutters 10 of the house can be selected to coordinate with a special theme or event, exteriorly and interiorly of the house. Decorative house flags, doormats, door wreaths, mailbox covers, yard signs, landscape designs or the flowers thereof, towels, tea towels, place mats, interior throw rugs, art work, wall borders, and even the clothing of the residents of the house can be designed to coordinate with the ornaments 12.

If the exterior shutters 10 are operable, and in an open position with ornaments 12 on, or about the outer face thereof, the operable exterior shutters 10 may be closed to protect the window, which will position the ornaments 12 inwardly toward the window. Operable exterior shutters 10 may have ornaments 12 and/or other embodiments disclosed herein, attached either on at least a portion of at least planar surface which may be on, or about the inner face and/or the outer face thereof and may further present thematic displays thereon which may be the same, similar, or substantially different.

When not in use, the ornaments 12 can be easily disposed of, or stored for future use if applicable to the embodiment in use.

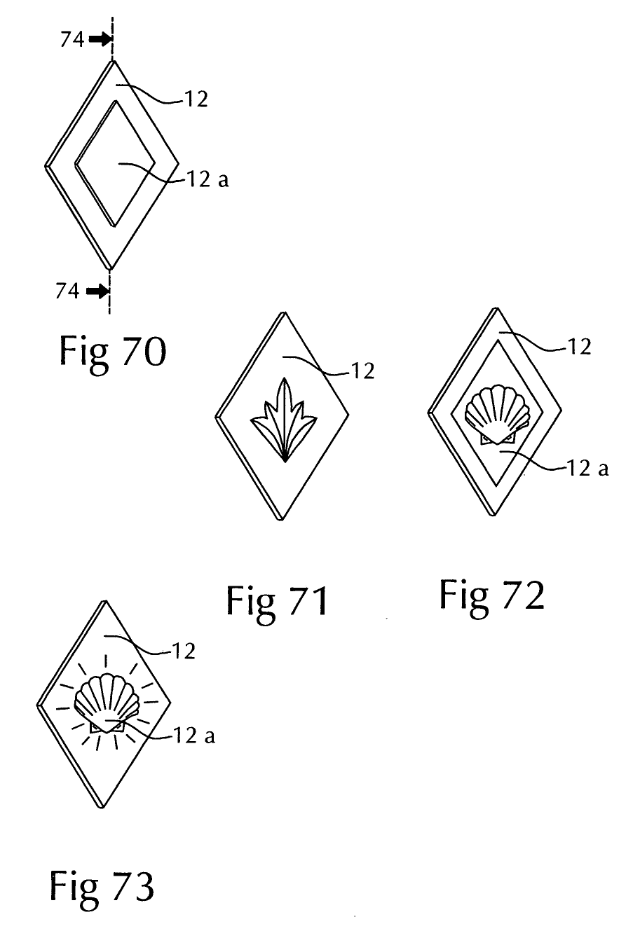

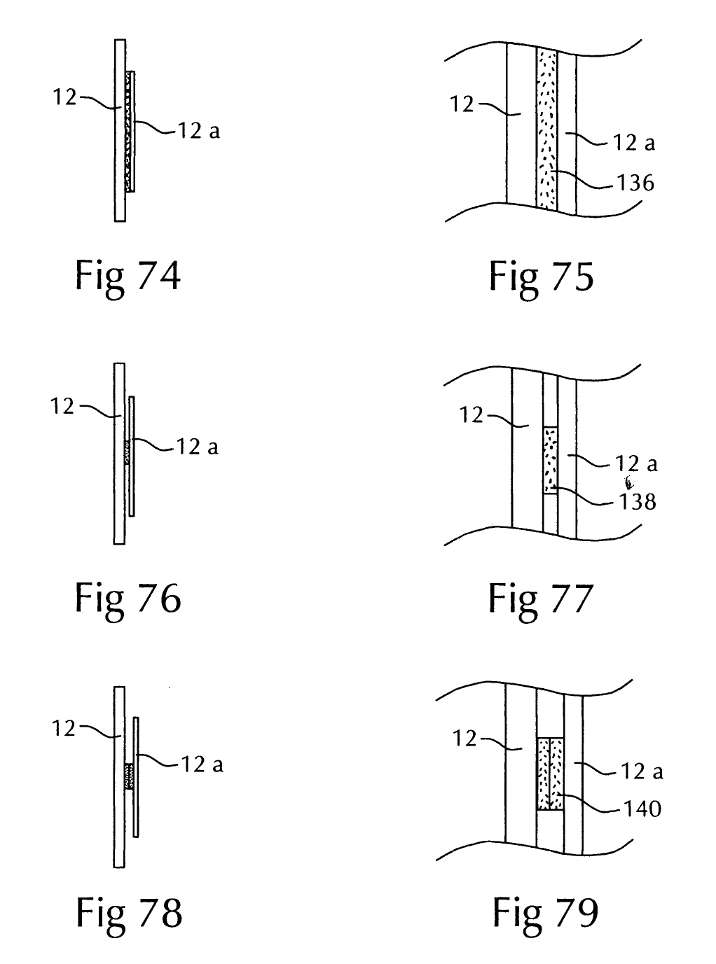

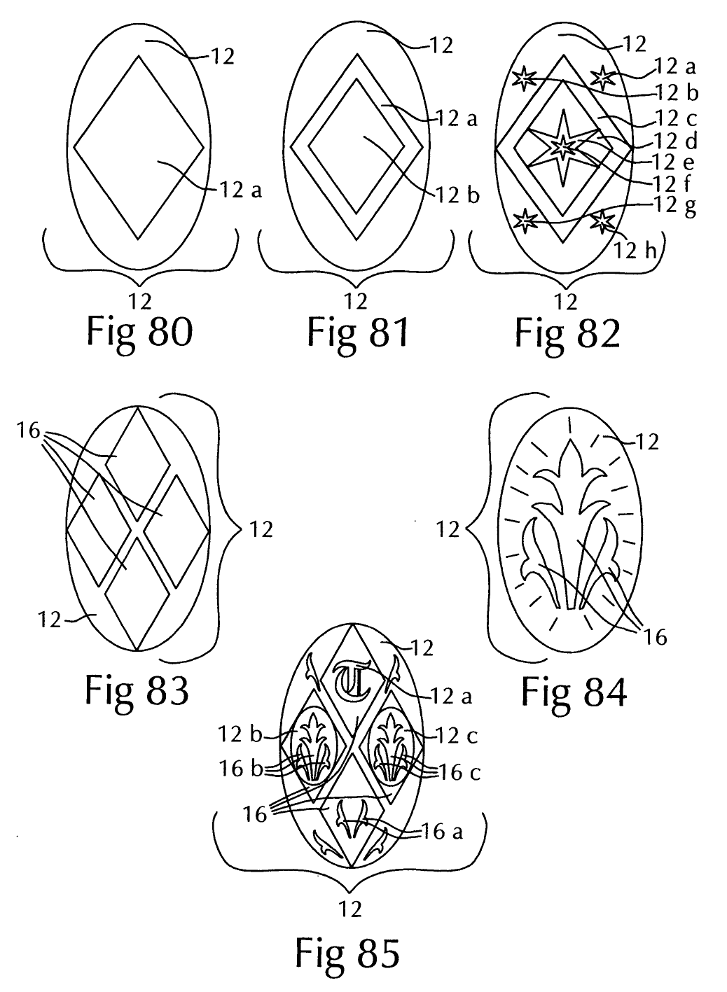

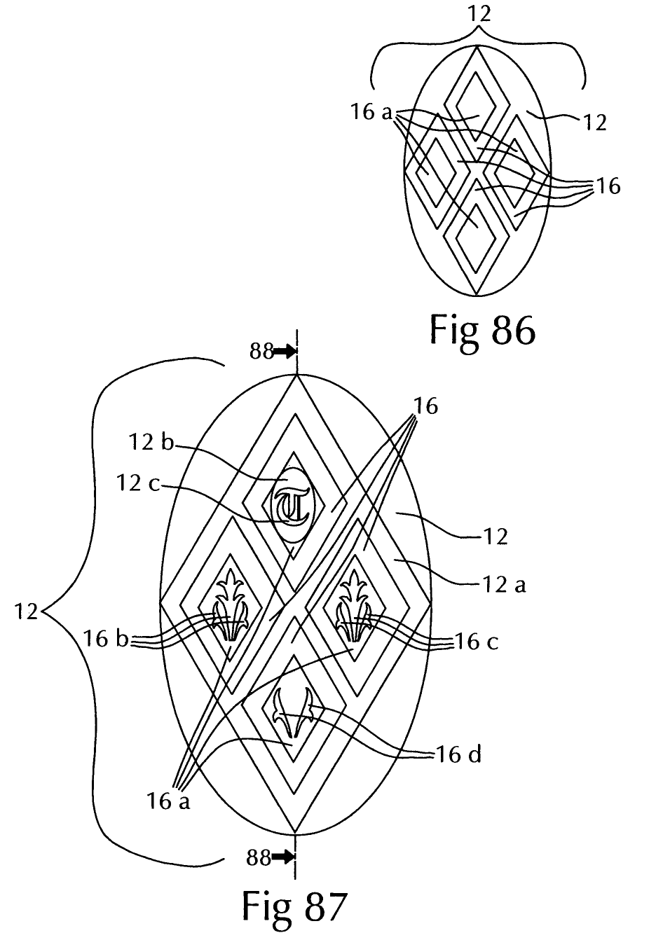

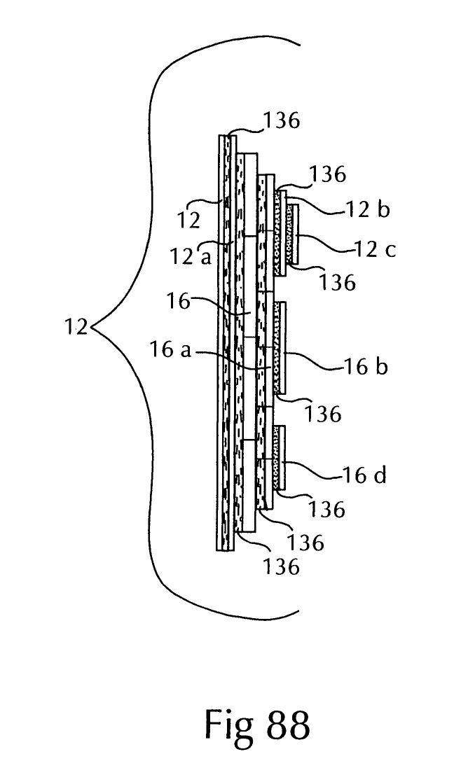

As shown in a most simplistic form for the sake of clarity, FIG. 70 shows how each, ornament 12 may have at least one ornament 12a, which may be removably attached to at least a portion of at least planar surface, which may be on, or about the outer face thereof. The ornament 12a, which may be removably attached to at least a portion of at least planar surface that may be on, or about the outer face of the ornament 12 may for example, thematically compliment the selected decoration that the ornament 12 is presenting as shown by example in FIG. 70, or may for example, present at least one entirely new decoration which may either cover or conceal the decoration that the ornament 12 is presenting as shown in the before and after examples of FIGS. 71 and 72, or may still further as another example, present at least one new decoration on the outer face of the ornament 12 (FIG. 73). Further shown in FIG. 73, is another example of how photoluminescence may be used in any desirable application, which may be related to the present invention. As shown by example in most simplistic form for the sake of clarity in FIGS. 74-79, the attachment means which my be used to attach at least a portion of at least planar surface which may be on, or about the inner face of at least one ornament 12 a, to at least a portion of at least planar surface which may be on, or about the outer face of at least a second ornament 12 may be for example, pressure-sensitive adhesives 136, double coated pressure-sensitive tapes, strips, pads or the like 138, hook and loop or similar types of reclosable fasteners 140. These are by no means the only at least removable attachment means which may be used to at least removably attach at least one ornament 12a, to at least a portion of at least planar surface which may be on, or about the outer face of at least a second ornament 12. Other attachment means such as, for example, static cling, water-washable tacky elastomer, adhesive tabs, aerosol adhesives, suction cups or similar like suction cup devices, hook, clip, or clamp like devices or members, male and female connecters, snaps, pins and pegs, clasps, brackets, channels, bars and grooves, friction fit devices, any suitable combinations thereof, as well as other attachment means known to those skilled in the art may alternately be used to removably attach at least one ornament 12a, to at least a portion of at least planar surface which may be on, or about the outer face of at least a second ornament 12, whereby expanding the versatility of the previously presented changeable display system which was presented on the exterior of a house, and still further providing many alternatives for changing the exterior appearance of a house having exterior shutters 10 attached thereto. The same drawings that were previously used in FIGS. 18-26 will now be used to represent a series of different examples in FIGS. 80-88. FIGS. 80-82 show three different front view examples, which further show the versatile nature afforded the ornaments 12 when removably attaching at least one, or a plurality of ornaments 12 to at least a portion of at least planar surface that may be on, or about the outer face of at least one ornament 12 and/or a plurality of ornaments 12 which may be consecutively layered on, or about at least a portion of at least planar surface which may be on the outer face of at least one ornament 12 using attachment means previously disclosed herein, any suitable combination thereof, or other attachment means known in the art. FIGS. 83 and 84, show two front view examples of how a plurality of ornaments 12 may be removably attached in a predetermined grouping on, or about at least a portion of at least planar surface which may be on the outer face of at least one ornament 12, each ornament 12 within the grouping is positioned in a close proximity in relation to the other ornaments 12 within the grouping, wherein all of the ornament's 12 at least predetermined shapes and/or at least portions of decorative surface further cooperate collectively as a group to present a single display or decorative ensemble 16, which as shown by example in FIGS. 83 and 84, may be removably attached on, or about at least a portion of at least planar surface which may be on the outer face of at least one ornament 12 using attachment means previously disclosed herein, any suitable combination thereof, or other attachment means known in the art. The decorative ensemble 16 which may be removably attached on, or about at least a portion of at least planar surface, which may be on, or about the outer face of at least one ornament 12 may be comprised of two or more ornaments 12. Further shown in FIG. 84, is another example showing how photo-luminescence may be used in various and/or any applications related to the present invention. FIG. 85 further shows an example of how at least the decorative ensemble 16 shown in FIG. 83, which may be removably attached on, or about the outer face of the ornament 12 as shown in FIG. 83, may further be afforded with at least one ornament 12b and/or at least one decorative ensemble 16a, each of which may additionally be removably attached thereto using attachment means previously disclosed herein, any suitable combination thereof, or other attachment means known in the art on, or about at least a portion of at least planar surface which may be on the outer face of at least one of the decorative elements which further collectively represent the decorative ensemble 16 in (FIG. 85). FIG. 85 further shows an example of how a plurality of decorative ensembles 16, 16a, 16b, 16c and a plurality of ornaments 12, 12a, 12b, and 12c, may be removably attached or assembled, using attachment means previously disclosed herein, any suitable combination thereof, or other attachment means known in the art, on at least a portion of at least planar surface which may be on, or about the outer face of at least one ornament 12 in any desirable fashion including the layering thereof, and still further providing many obvious variable alternatives when improving and/or changing the appearance of the ornament 12 and/or the theme which may be presented in a display system on the exterior shutters 10 of the house. FIG. 86, still even further shows an example of how at least the decorative ensemble 16 shown in FIG. 83, which may be removably attached on, or about at least a portion of at least planar surface which may be on the outer face of the ornament 12 as shown in FIG. 83, may further have at least a second, at least similar like decorative ensemble 16 removably attached on, or about the outer face thereof using attachment means previously disclosed herein, any suitable combination thereof, or other attachment means known in the art. FIGS. 87-88 shows yet another example of how different variable combinations of ornaments 12 and decorative ensembles 16 may be removably attached on, or about the outer face of the ornament 12 in any desirable fashion including the layering thereof using attachment means such as, for example, pressure sensitive adhesive 136, any attachment means previously disclosed herein, any suitable combination thereof, or other attachment means known in the art.

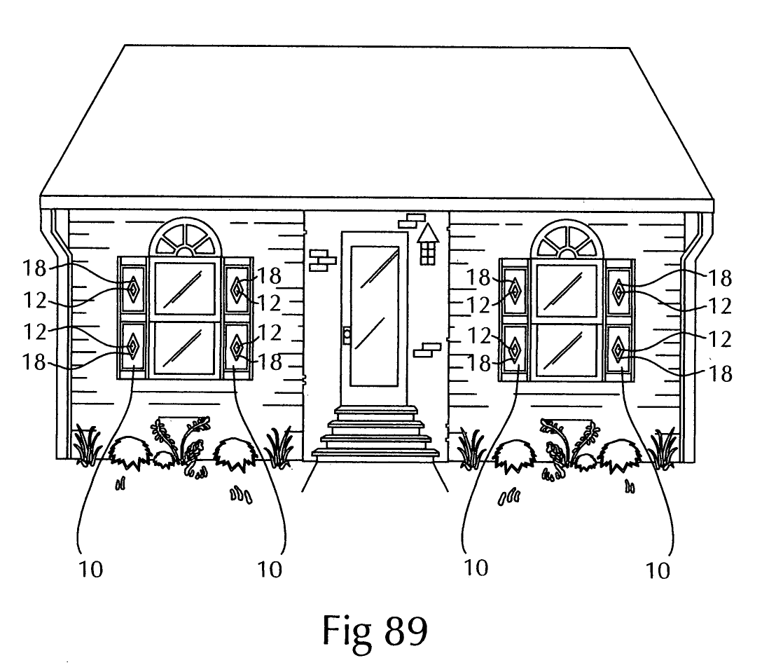

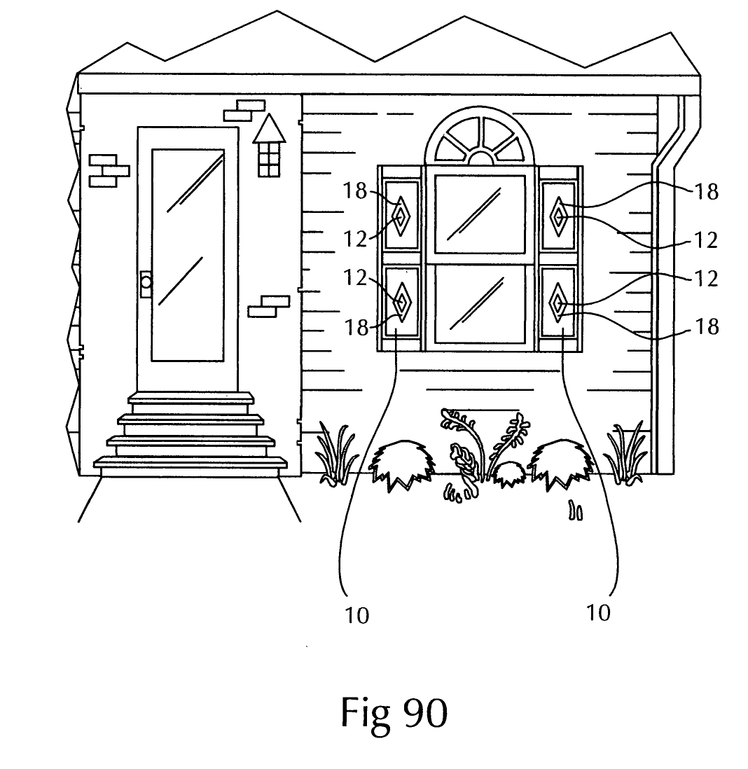

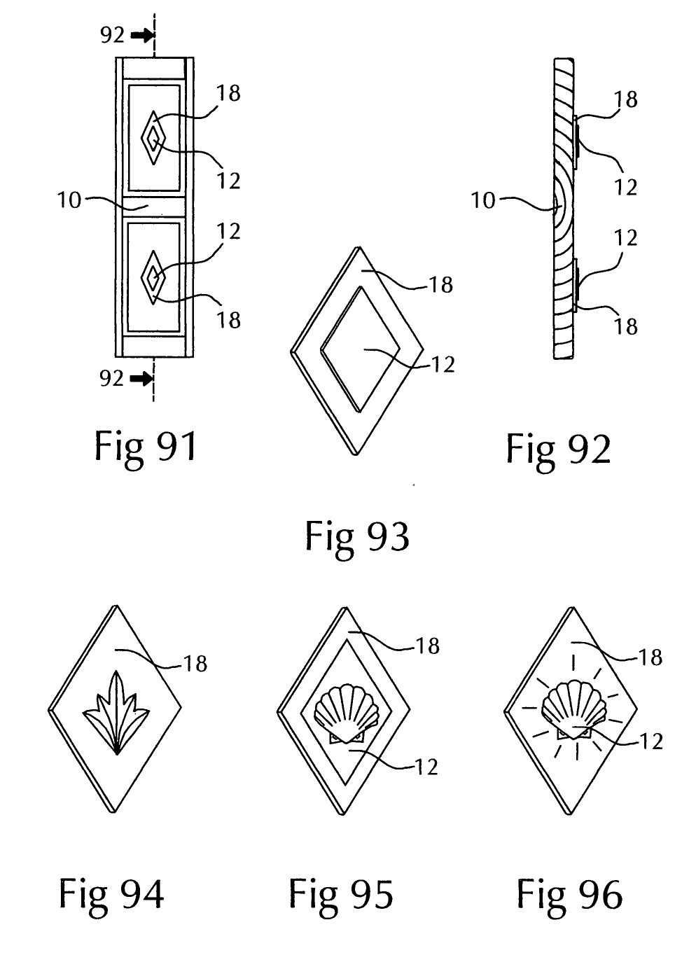

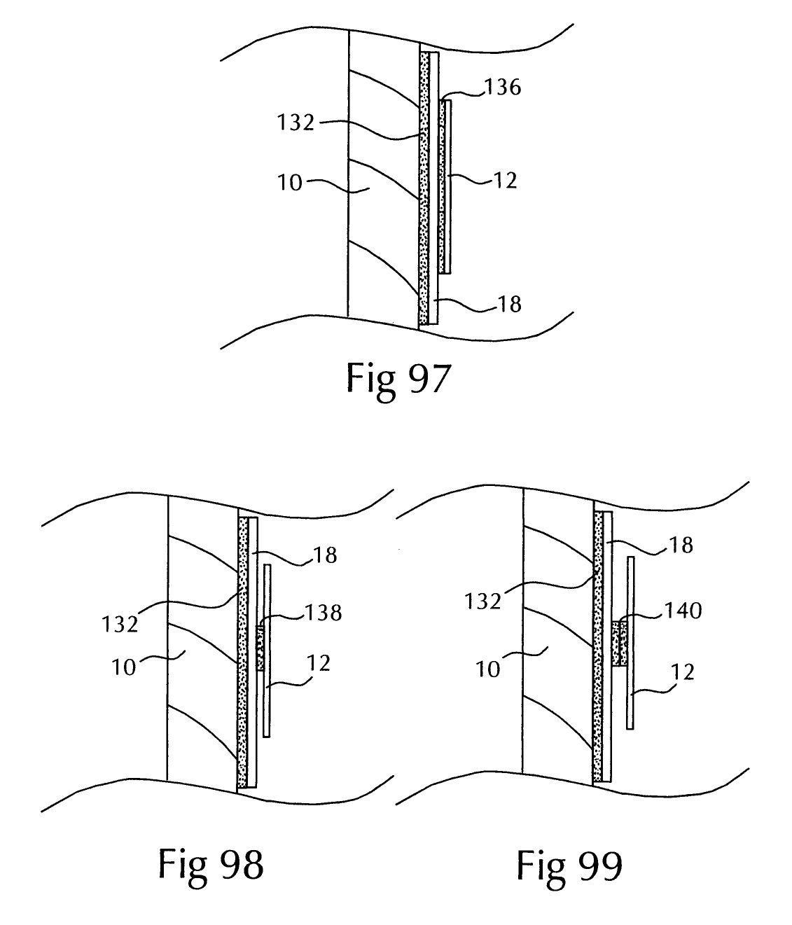

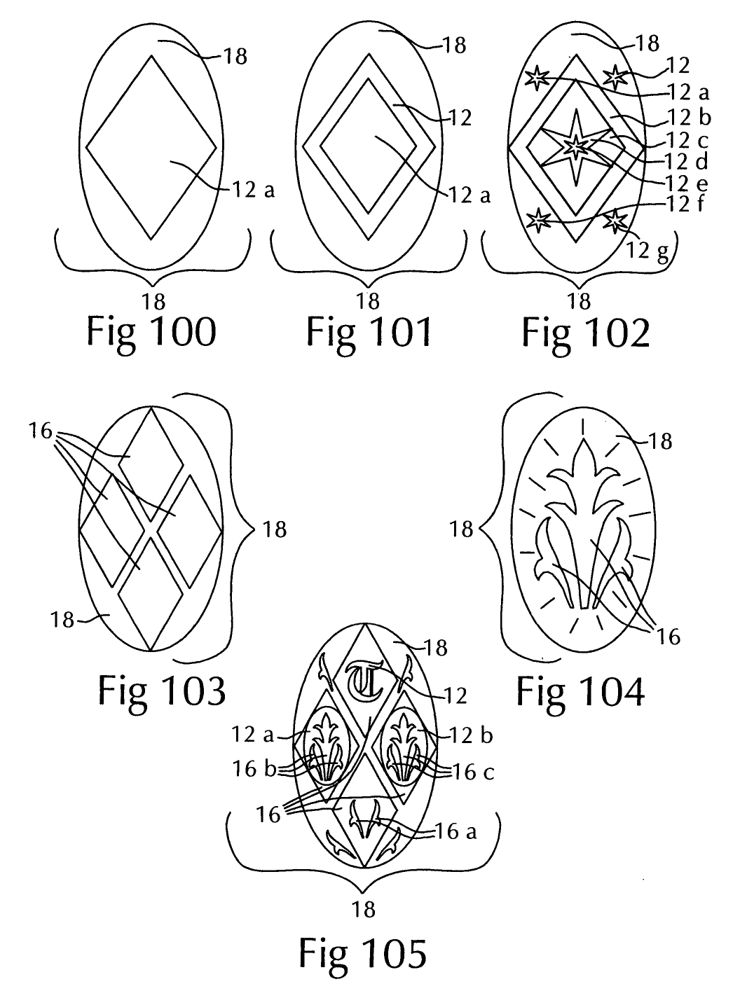

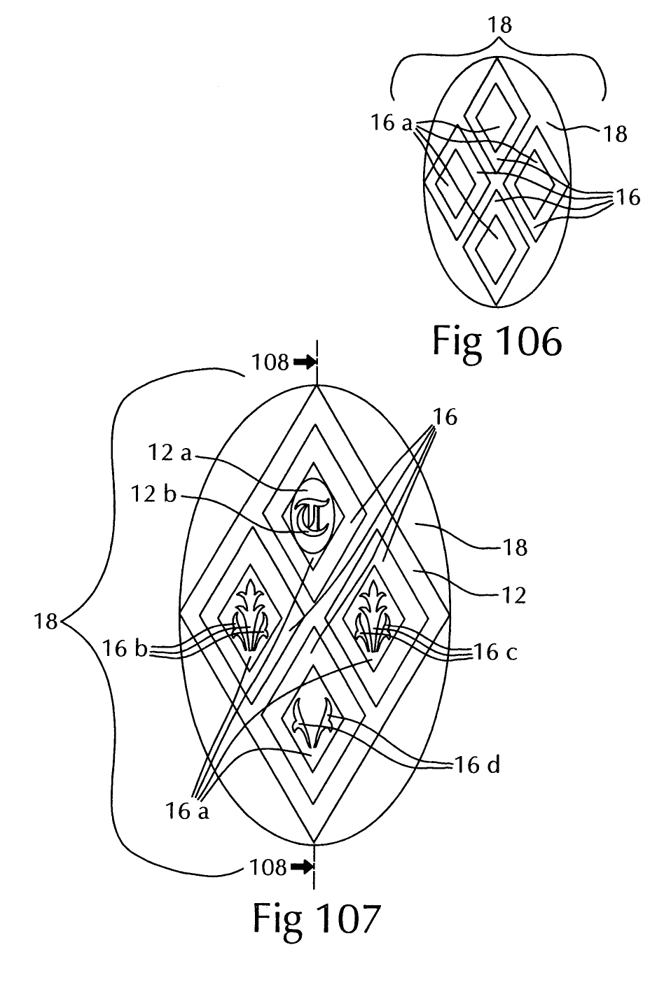

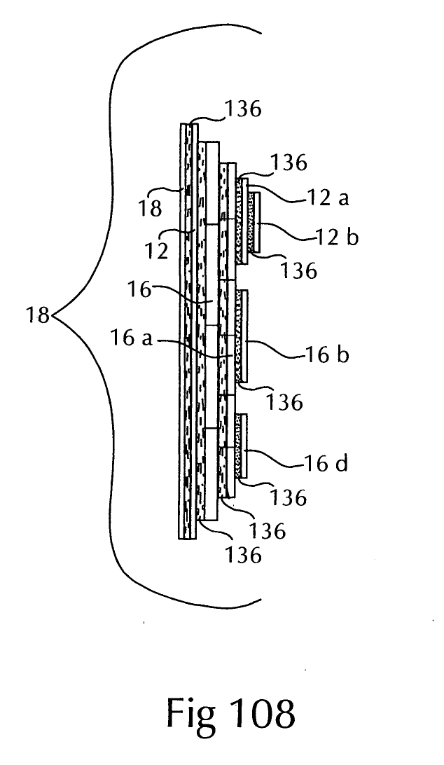

As shown in FIGS. 89-92, a permanently mounted, changeable display system for a house having exterior shutters 10 attached thereto is disclosed, wherein a plurality of ornaments 12 are each permanently attached to at least a portion of at least planar surface which may be on, or about the outer face of the exterior shutters 10 of the house, and are each at that point converted to an ornamental base mount 18. The ornamental base mounts 18 are each further provided with at least one ornament 12, which may be removably attached to at least a portion of at least planar surface that may be on, or about the outer face thereof. The ornamental base mounts 18 are afforded the same amenities that are afforded the ornaments 12 as disclosed herein. The ornamental base mounts 18, each having a structural body which is preferably substantially smaller in relation as compared to the height and width dimensions of the exterior shutters 10, and are each further made of at least one decorative element comprised of at least a portion of suitable material having at least a predetermined shape and/or at least a portion of decorative surface thereof, an inner face, and an outer face, and at least one ornament 12 which may be removably attached to at least a portion of at least planar surface which may be on, or about the outer face thereof. The ornamental base mounts 18, each having a selected decoration, which collectively represent a theme, are each permanently attached to at least a portion of at least planar surface which may be on, or about the outer face of the exterior shutters 10 of the house, to present a display system related to the theme. The ornamental base mount's 18 selected decorations are generally designed to display a permanent base theme for the exterior of the house or the exterior shutters 10 thereof. Moreover, the ornamental base mount's 18 selected decorations, due to the fact that they are permanent, typically in a collective fashion will preferably represent a theme such as, for example, a regal or majestic like theme or any desirable theme which may be displayed all year long, and not limited to a specific season, holiday, etc. The same drawings that were previously used in FIGS. 70-73 will now be used to represent a series of different examples in FIGS. 93-96. As the example shows in FIG. 93, the at least one ornament 12, which may be removably attached to at least a portion of at least planar surface that may be on, or about the outer face of each ornamental base mount 18, may thematically compliment the selected decoration that the at least ornamental base mount 18 may be presenting, or as shown in the before and after examples of FIGS. 94-95, may further present at least one entirely new decoration which may either cover or conceal the decoration that the ornamental base mount 18 may be presenting, or as shown by example in FIG. 96, may still further present at least one new decoration which may be on, or about the outer face of the ornamental base mount 18. FIG. 96 is yet another example showing how photo-luminescence may be used in various and/or any applications related to the present invention. The ornamental base mount 18 may be permanently attached to at least a portion of at least planar surface which may be on, or about the outer face of the exterior shutter 10 by any suitable attachment means known to those skilled in the art, as further shown in most simplistic form for the sake of clarity in (FIGS. 97-99). Attachment means such as, for example, adhesives, glues, epoxies, and cements 132, may be used to permanently attach at least a portion of at least planar surface which may be on, or about the inner face of at least one ornamental base mount 18 to at least a portion of at least planar surface which may be on, or about the outer face of the exterior shutter 10. These are by no means the only permanent attachment means, which may be used to attach at least one ornamental base mount 18 to at least a portion of at least planar surface which may be on, or about the outer face of the exterior shutter 10. Other attachment means such as, for example, screws or similar like fasteners, male connecters, male and female connecters, nails, rivets, hot melts, chemical bonding, welding, machine or industry processes known in the art, as well as other attachment means known in the art, may alternately be used to permanently attach at least one ornamental base mount 18 to at least a portion of at least planar surface which may be on, or about the outer face of the exterior shutter 10. The ornamental base mounts 18 each have at least one ornament 12 which may be removably attached to at least a portion of at least planar surface which may be on, or about the outer face thereof as further shown in most simplistic form for the sake of clarity in FIGS. 97-99, with attachment means such as, for example, pressure-sensitive adhesives 136, double coated pressure-sensitive tapes, strips, pads or the like 138, hook and loop or similar types of reclosable fasteners 140 on at least a portion of at least planar surface which may be on, or about the inner face of at least one ornament 12 and on at least a portion of at least planar surface which may be on, or about the outer face of the ornamental base mount 18. These are by no means the only removable attachment means which may be used to removably attach the at least one ornament 12 to at least a portion of at least planar surface which may be on, or about the outer face of the ornamental base mount 18. Other attachment means such as, for example, static cling, water-washable tacky elastomer, adhesive tabs, aerosol adhesives, suction cups or similar like suction cup devices, hook, clip or clamp like members or devices, male and female connecters, snaps, pins and pegs, wires, clasps, brackets, channels, bars and grooves, friction fit devices, as well as other removable attachment means known to those skilled in the art, may alternately be used to removably attach the at least one ornament 12 to at least a portion of at least planar surface which may be on, or about the outer face of the ornamental base mount 18. The same drawings that were previously used in FIGS. 18-26 and 80-88 will now be used to represent a series of different examples in FIGS. 100-108. FIGS. 100-102 show three different front view examples, which further show the versatile nature afforded the ornamental base mounts 18 when removably attaching at least one and/or a plurality of ornaments 12 to at least a portion of at least planar surface that may be on, or about the outer face of the ornamental base mount 18 and/or a plurality of ornaments 12 which may be consecutively layered on, or about at least a portion of at least planar surface which may be on the outer face of the ornamental base mount 18 using attachment means previously disclosed herein, any suitable combinations thereof, or other attachment means known in the art. FIGS. 103 and 104, show two front view examples of how a plurality of ornaments 12 may be removably attached in a predetermined grouping on, or about at least a portion of at least planar surface which may be on the outer face of the ornamental base mount 18, each ornament 12 within the grouping is positioned in a close proximity in relation to the other ornaments 12 within the grouping, wherein all of the ornament's 12 at least predetermined shapes and/or at least portions of decorative surface thereof, further cooperate collectively as a group to present a single display or decorative ensemble 16, which as shown by example in FIGS. 103 and 104, may be removably attached on, or about at least a portion of at least planar surface which may be on the outer face of the ornamental base mount 18 using attachment means previously disclosed herein, any suitable combinations thereof, or other attachment means known in the art. The decorative ensemble 16 which may be removably attached on, or about at least a portion of at least planar surface which may be on the outer face of the ornamental base mount 18, may be comprised of two or more ornaments 12. Further shown in FIG. 104, is still yet another example showing how photo-luminescence may be used in any desirable applications, which may be deemed as related to the present invention. FIG. 105 further shows an example of how the decorative ensemble 16 shown in FIG. 103, which may be removably attached to the outer face of the ornamental base mount 18 as shown in FIG. 103, may further be afforded with at least one ornament 12 and/or at least one decorative ensemble 16a, each of which may additionally be removably attached thereto using attachment means previously disclosed herein, any suitable combinations thereof, or other attachment means known in the art on, or about at least a portion of at least planar surface which may be on the outer face of at least one of the ornaments 12, which collectively represent the decorative ensemble 16 in FIG. 105. FIG. 105 further shows an example of how a plurality of decorative ensembles 16, 16a, 16b, 16c and a plurality of ornaments 12, 12a, 12b, and 12c, may be removably attached or assembled, using attachment means previously disclosed herein, any suitable combinations thereof, or other attachment means known in the art, on at least a portion of at least planar surface which may be on, or about the outer face of the ornamental base mount 18 in any desirable fashion including the layering thereof, and still further providing many obvious variable alternatives when improving, or changing the appearance of the ornamental base mount 18 and/or in a collective fashion, the theme presented for the exterior of the house. FIG. 106, still even further shows an example of how the decorative ensemble 16 shown in FIG. 103, which may be removably attached on, or about at least a portion of at least planar surface which may be on the outer face of the ornamental base mount 18 as shown in FIG. 103, may further have at least a second, at least similar like decorative ensemble 16 removably attached on, or about the outer face thereof using attachment means previously disclosed herein, any suitable combinations thereof, or other attachment means known in the art. FIGS. 107-108 shows yet another example of how different variable combinations of ornaments 12 and decorative ensembles 16 may be removably attached on, or about the outer face of the ornamental base mount 18 in any desirable fashion including the layering thereof using attachment means such as, for example, pressure sensitive adhesive 136, any attachment means previously disclosed herein, any suitable combinations thereof, or other attachment means known in the art.

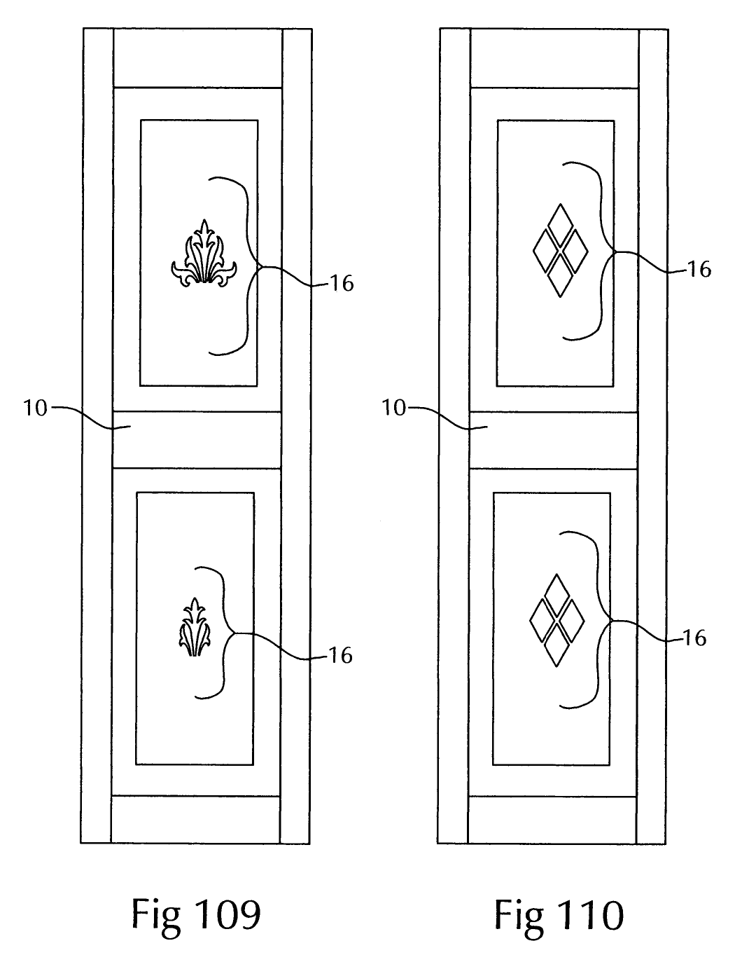

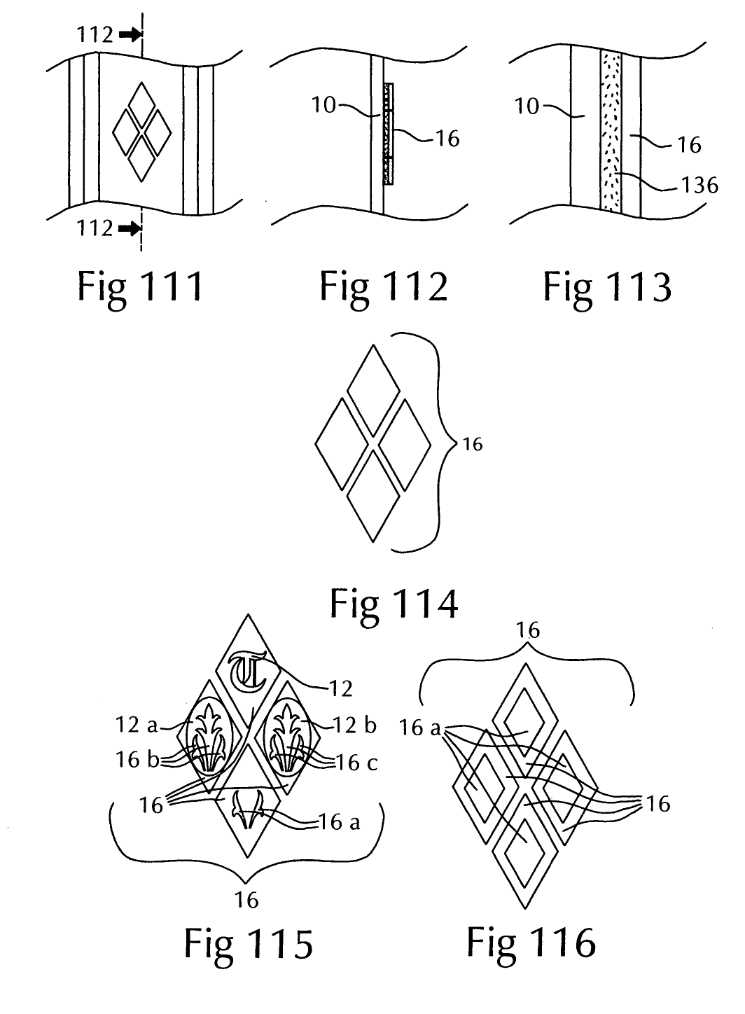

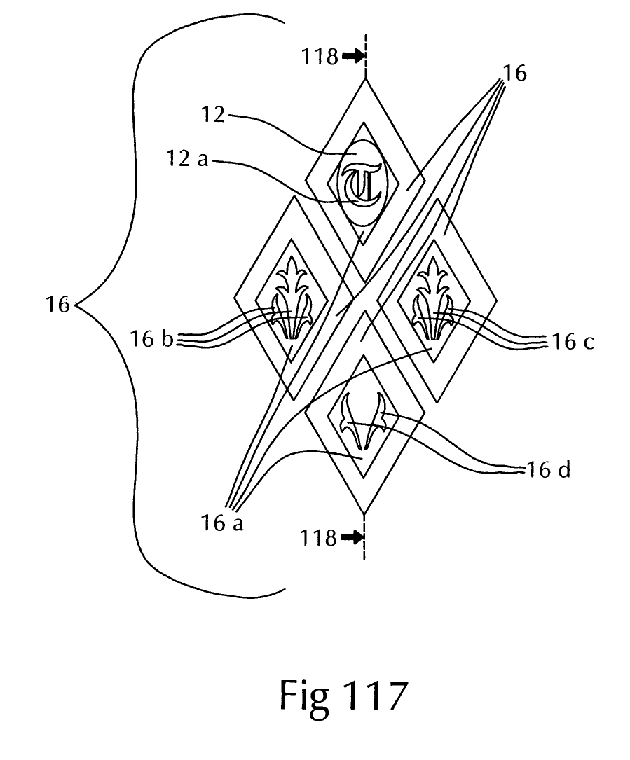

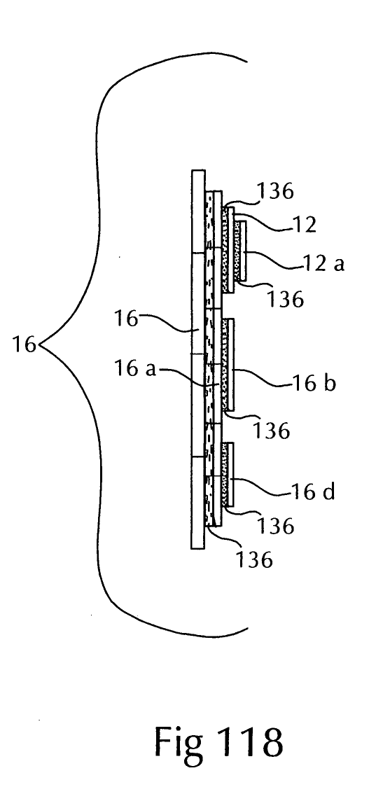

A plurality of ornaments 12 may be removably attached to at least a portion of at least planar surface which may be on, or about the outer face of the exterior shutter 10 in a predetermined grouping, each ornament 12 within the grouping is positioned in close proximity in relation to the other ornaments 12 within the grouping, wherein all of the ornament's 12 at least predetermined shapes and/or at least portions of decorative surface thereof, further cooperate collectively as a group to present a single display or decorative ensemble 16, FIGS. 109-110. The collective group of ornaments 12 comprising the decorative ensemble 16 may be removably attached to at least a portion of at least planar surface, which may be on, or about the outer face of the exterior shutter 10 as shown in most simplistic form for the sake of clarity in FIGS. 111-113, using attachment means such as, for example, pressure sensitive adhesive 136, any attachment means previously disclosed herein, any suitable combinations thereof, or other attachment means known in the art. FIG. 114 shows the example of the decorative ensemble 16, which was previously shown removably attached to the exterior shutter 10 in FIGS. 111-113. FIG. 115 further shows an example of how the decorative ensemble 16 shown in FIG. 114, may further be afforded with at least one ornament 12 and/or at least one decorative ensemble 16a, each of which may additionally be removably attached thereto using attachment means previously disclosed herein, any suitable combination thereof, or other attachment means known in the art on, or about at least a portion of at least planar surface which may be on the outer face of at least one of the ornaments 12, which collectively represent the decorative ensemble 16 in (FIG. 115). FIG. 115 further shows an example of how a plurality of decorative ensembles 16, 16a, 16b, 16c and a plurality of ornaments 12, 12a, 12b, and 12c, may be removably attached or assembled, using attachment means previously disclosed herein, any suitable combination thereof, or other attachment means known in the art, on at least a portion of at least planar surface which may be on, or about the outer face of the decorative ensemble 16 in any desirable fashion including the layering thereof, and still further providing many obvious variable alternatives when improving, or changing the appearance of the decorative ensemble 16 and/or in a collective fashion, the theme which is to be presented on the exterior of the house. FIG. 116, still even further shows an example of how the decorative ensemble 16 shown in FIG. 114, which may be removably attached on, or about at least a portion of at least planar surface which may be on the outer face of the exterior shutter 10 as shown in FIGS. 111-113, may further have at least a second, at least similar like decorative ensemble 16 removably attached on, or about the outer face thereof using attachment means previously disclosed herein, any suitable combination thereof, or other attachment means known in the art. FIGS. 117-118 shows yet another example of how different variable combinations of ornaments 12 and decorative ensembles 16 may be removably attached on the outer face of the decorative ensemble 16 in any desirable fashion including the layering thereof, using pressure sensitive adhesive 136, any attachment means previously disclosed herein, any suitable combinations thereof, or other attachment means known in the art.

If the group of ornaments 12 which comprise the decorative ensemble 16 are flexible, or semi-flexible having pressure-sensitive adhesive 136 on at least a portion of at least planar surface which may be on, or about the inner face thereof, the group of ornaments 12 comprising the decorative ensemble 16 may each be placed in position, adhesive side down, on a single protective backing sheet to protect the adhesives until usage, or may alternately each have individual protective backing sheets, and further have a transfer sheet, strip, strips or similar transferring means known in the art tacked on, or about the decorative and/or outer face thereof with a low grade adhesive, whereby the decorative ensemble 16 may be removably attached to at least a portion of at least planar surface which may be on, or about the outer face of the at least exterior shutter 10 by removing the protective backing sheet or sheets from the inner face portions of the decorative ensemble 16 and exposing the pressure sensitive adhesive 136 on the inner face portions comprising the decorative ensemble 16, the transfer sheet, strip, strips or the like are then used to accurately transfer or removably attach the inner face adhesive side of the decorative ensemble 16 on at least a portion of at least planar surface which may be on, or about the outer face of the exterior shutter 10 in a uniform fashion, the transfer sheet, strip, strips or the like are then easily peeled off of the outer face of the decorative ensemble 16 further exposing a perfectly positioned decorative ensemble 16 on at least a portion of at least planar surface which may be on, or about the outer face of the exterior shutter 10. The transfer sheet, strip, strips or the like may be transparent or opaque, or may have guide lines which may be on, or about a surface thereof, or may be in any other form known in the art which may alternately be used to help ensure an accurate transfer. The group of ornaments 12 which comprise the decorative ensemble 16, using any attachment means previously disclosed herein, any suitable combinations thereof, or other attachment means known in the art, may also be individually positioned one at a time on at least a portion of at least planar surface which may be on, or about the outer face of the exterior shutter 10 to make the decorative ensemble 16. The transfer sheet, strip, strips or the like may also be used as well to removably attach individual ornaments 12 on at least a portion of at least planar surface which may be on, or about the outer face of the exterior shutter 10 in this manor if so desired. The transfer sheet, strip, strips or other transferring means known in the art may still further be used to removably and/or permanently transfer at least a portion and/or portions of any suitable material and/or materials related to the present invention on, or about any desirable at least portion and/or portions of at least planar surface which may be deemed as related to the present invention using any suitable attachment means disclosed herein, any suitable combinations thereof, or other attachment means known in the art. The decorative ensemble 16 may be displayed for lengthy periods of time or, if applicable to the present application, may be quickly and easily removed and/or changed when desired.

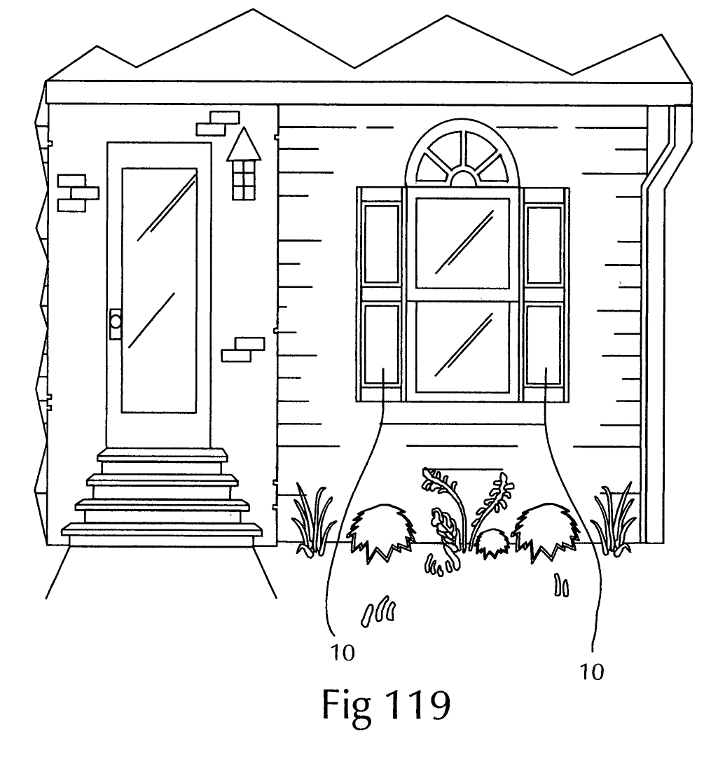

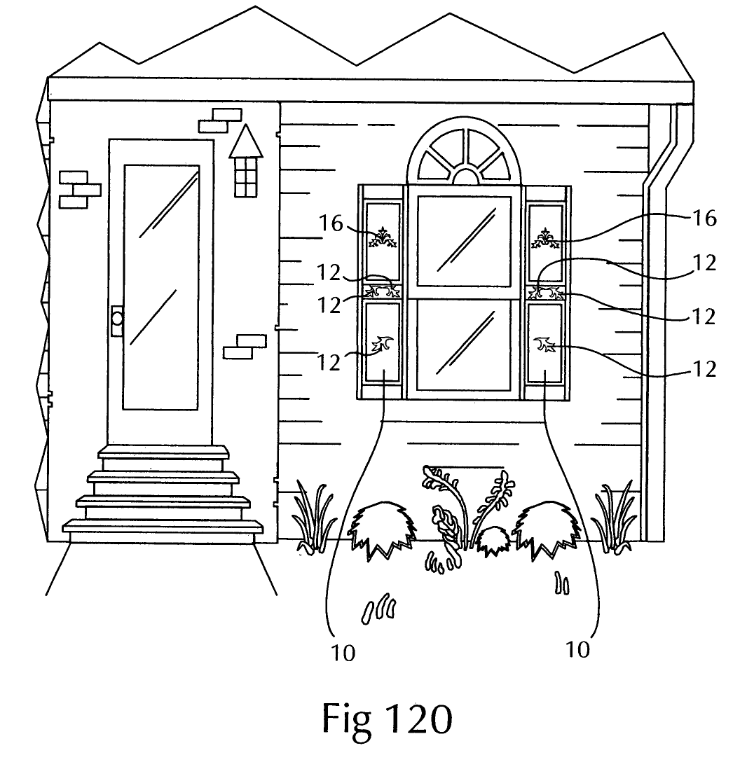

The ornaments 12 and/or other applicable embodiments, or any principles and/or applications thereof which may be further related to the present invention, may be used to provide a relatively inexpensive home improvement, which substantially further ads beauty to the exterior appearance of a house, whereby the inherent value and/or salability of the house may increase as a direct result. The at least ornaments 12 may provide an exquisite appearance for the exterior of the house that may be changeable and is further a distinct aesthetic improvement, which still further provides a decisively superior appearance as compared to a similar like house having no ornaments 12 on the exterior shutters 10 thereof, as shown in the before and after examples of FIGS. 119-120. The at least ornaments 12 therefore may be for example, used exclusively by one homebuilder or manufacturer to give them a substantial advantage in the homing industry by providing houses in a competitive market that are not only substantially more beautiful and attractive comparatively to similar like houses built and sold in the homing industry, but the homebuilder or manufacturer will also be offering new houses afforded with a changeable display system which may be easily changed as desired. The aspect of selling houses that are presenting a changeable display system provides many selling point advantages for the homebuilder or manufacturer such as, for example, depending on demographic location, the time of year, the season, an approaching holiday, and many other factors, any one of a vast array of powerful themes may be theatrically displayed upon the exteriors of the houses which are to be sold. Powerful themes are known to evoke emotional feelings within human beings. The themes that the at least ornaments 12 may present in a changeable display system on the exterior shutters 10 of the house are designed to collectively project a powerful theme that is visually stimulating. Visual stimulation is one key factor leading to an emotional response from within a human being, for example, a couple is walking toward the house that they may wish to purchase and from a substantial distance, the theme being projected from the house, which was strategically designed to project a warm home like feeling, may have a dramatic impact on the couple, whereby the collectively projected theme through visual stimulation creates warm home like emotional feelings within the couple which in turn may trigger an emotional response from within the couple, whereby if the couple feels at home due to the warm home like feelings which they are experiencing within, the odds for the couple purchasing the house or property may be dramatically increased. Therefore the homebuilder or manufacturer is provided with a substantial advantage in the homebuilding, or manufacturing industry and may further, as an end result, gain a substantially greater market share.

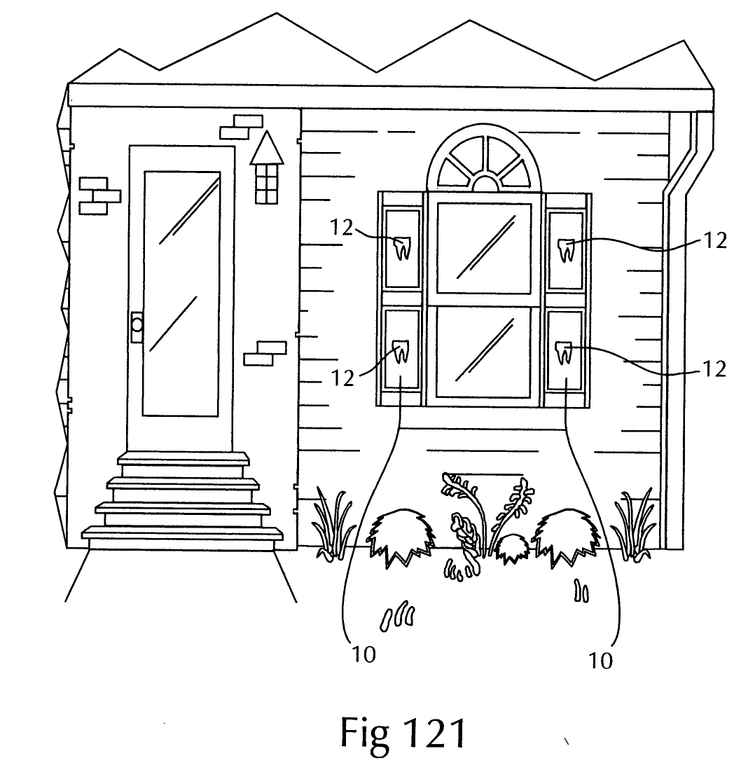

The ornaments 12 and/or other applicable embodiments, or any principles and/or applications thereof, which may be further related to the present invention, may be presented in a changeable display system on the exterior shutters 10 of a house to effectively communicate or express any desirable message. The at least predetermined shape and/or at least portion of decorative surface, which may be on, or about the inner face and/or the outer face of the ornaments 12, may present a message of any suitable subject material to persons whom may pass by the house and receive and/or see the presented message. FIG. 121, shows a message in the form of advertising, a plurality of human teeth are presented on the exterior shutters 10 to advertise the fact that the house is in fact, a dental office. The message may be changed as frequently as desired and any imaginable and/or desirable message may further be presented in a changeable display system on the exterior shutters 10 of the house in this manor.

The ornaments 12 and/or other applicable embodiments, or any principles and/or applications thereof which may be further related to the present invention, may be left in place, in a changeable display system on the exterior shutters 10 for years, or if applicable to the embodiments in use, may be changed as frequently as desired without causing any damage to the exterior shutters 10, or surfaces thereof. The ornaments 12 and/or decorative ensembles 16 may be removably attached to at least a portion of at least planar surface which may be on, or about the outer face of the exterior shutters 10 using at least attachment means previously disclosed herein, any suitable combinations thereof, or other attachment means known in the art, and at a substantially later date, the ornaments 12 and/or decorative ensembles 16 may be removed from the exterior shutters 10 without leaving adhesive residue, scarring, or similar like damages to surfaces which may be on, or about the at least outer face of exterior shutters 10.

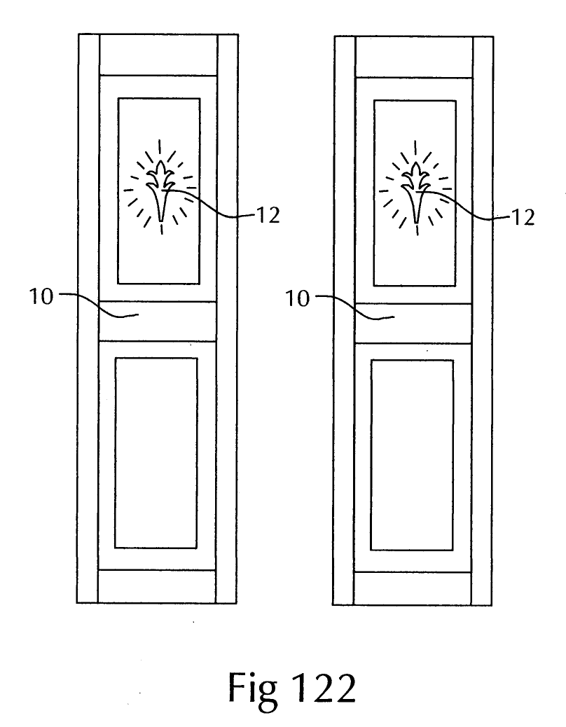

The ornaments 12 and/or decorative ensembles 16 of the present invention may be used in combination with a variety of variable methods of permanent surface treatment, each method of permanent surface treatment may be used as desired when treating at least a portion and/or portions of surface, which may be on the outer face of each exterior shutter 10 within at least one set. As shown in the example of FIG. 122, a plurality of exterior shutters 10 is provided along with a plurality of ornaments 12, the ornaments 12 each having a selected decoration and further possessing photo-luminescent like qualities. At least one ornament 12 having a selected decoration and further possessing photoluminescent like qualities is permanently attached to one of the exterior shutters 10. At least a second ornament 12 having the same selected decoration and further possessing photo-luminescent like qualities is permanently attached to the other exterior shutter 10 within the at least one set wherein the selected decorations are directed to a theme, and a display system related to the theme is presented which may further glow in the dark to present a nighttime display.

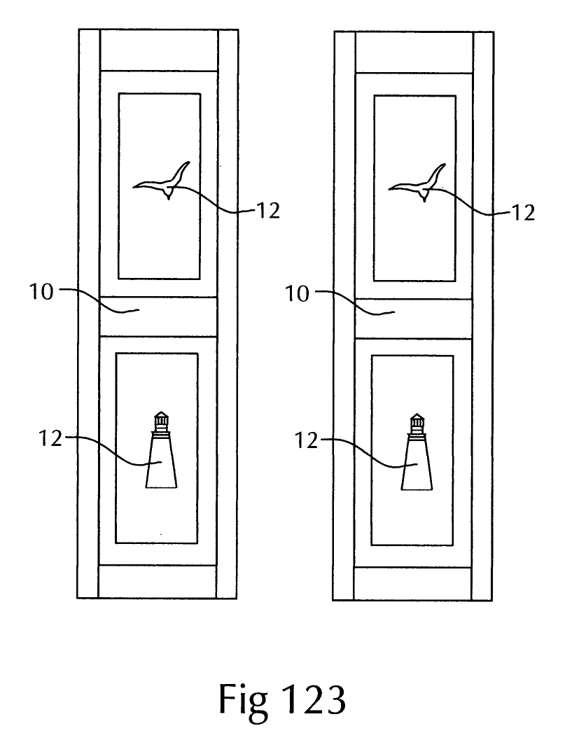

As shown in the example of FIG. 123, a plurality of exterior shutters 10 is provided along with plurality of ornaments 12, each ornament 12 further having a selected decoration. One of the ornaments 12 having a selected decoration is permanently attached to one of the exterior shutters 10, and least a second ornament 12 having a different selected decoration is permanently attached to the same exterior shutter 10 wherein the selected decorations are directed to a theme. The permanent attaching of ornaments 12 is repeated on the other exterior shutter 10 within the at least one set to present a display system related to the theme.

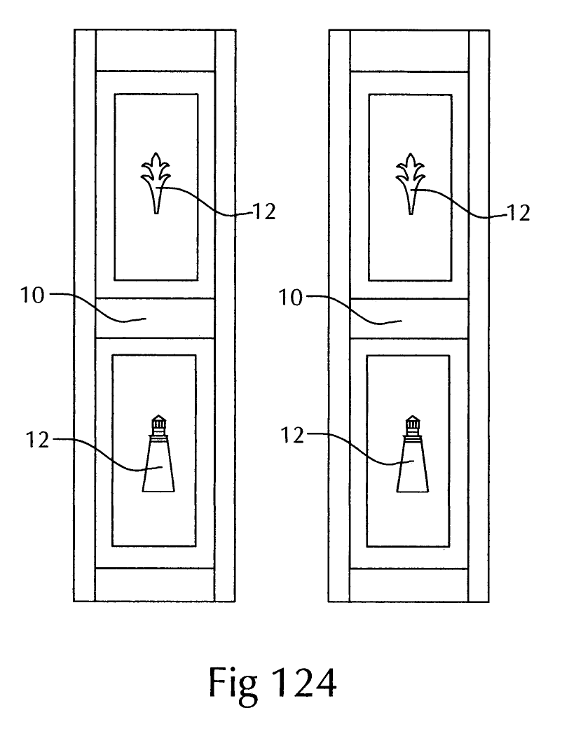

As shown by example in FIG. 124, a plurality of exterior shutters 10 is provided along with a plurality of ornaments 12, each ornament 12 further having a selected decoration. One of the ornaments 12 having a selected decoration is permanently attached to one of the exterior shutters 10 and at least a second ornament 12 having a different selected decoration is permanently attached to the same exterior shutter 10, wherein the selected decorations are directed to at least two different themes, which further aesthetically compliment each other. The permanent attaching of ornaments 12 is repeated on the other exterior shutter 10 within the at least one set to present a display system related to at least two different themes which are further aesthetically complimenting of one another.

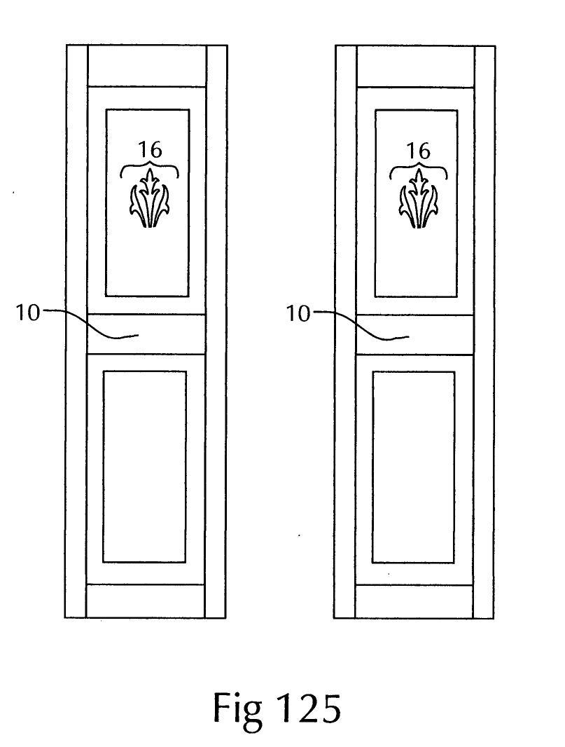

FIG. 125 shows an example wherein a plurality of exterior shutters 10 is provided along with plurality of decorative ensembles 16, each decorative ensemble 16 further having a selected decoration. At least one decorative ensemble 16 having a selected decoration is permanently attached to one of the exterior shutters 10, and at least a second decorative ensemble 16 having the same selected decoration is permanently attached to the other exterior shutter 10 within the at least one set, wherein the selected decorations are directed to a theme and a display system related to the theme is presented.

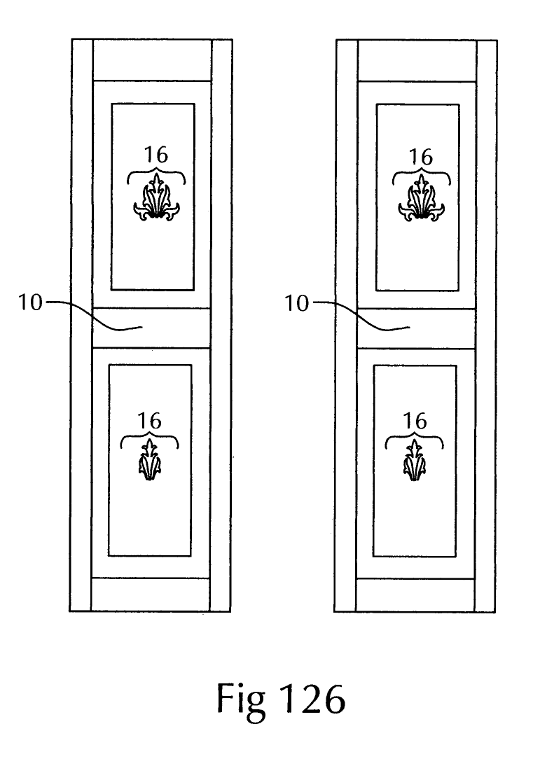

As shown in the example of FIG. 126, a plurality of exterior shutters 10 is provided along with a plurality of decorative ensembles 16, the decorative ensembles 16 each further having a selected decoration. One of the decorative ensembles 16 having a selected decoration is permanently attached to one of the exterior shutters 10, and at least a second decorative ensemble 16 having a different selected decoration is permanently attached to the same exterior shutter 10 wherein the selected decorations are directed to a theme. The permanent attaching of decorative ensembles 16 is repeated on the other exterior shutter 10 within the at least one set to present a display system related to the theme.

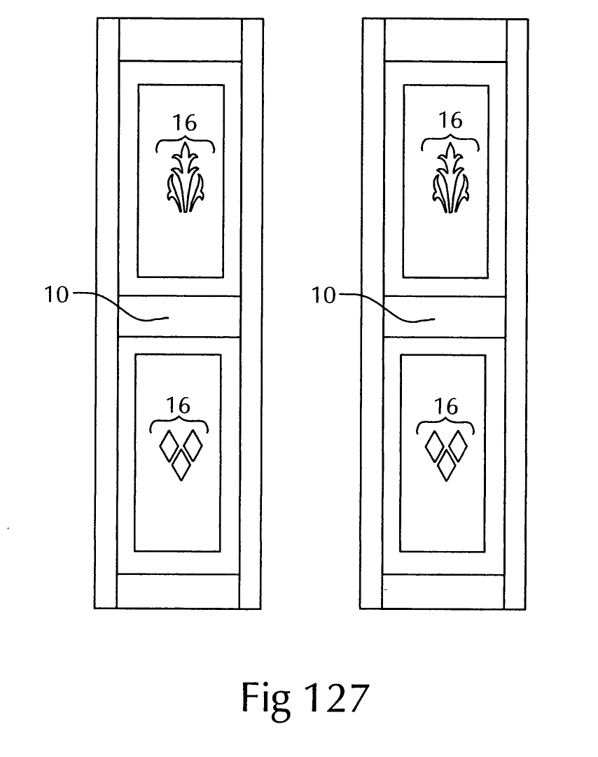

As shown in the example of FIG. 127, a plurality of exterior shutters 10 is provided along with a plurality of decorative ensembles 16, the decorative ensembles 16 each further having a selected decoration. One of the decorative ensembles 16 having a selected decoration is permanently attached to one of the exterior shutters 10 and at least a second decorative ensemble 16 having a different selected decoration is permanently attached to the same exterior shutter 10 wherein the selected decorations are directed to at least two different themes, which further aesthetically compliment each other. The permanent attaching of decorative ensembles 16 is repeated on the other exterior shutter 10 within the at least one set to present a display system related to at least two different themes which are further aesthetically complimenting to one another.

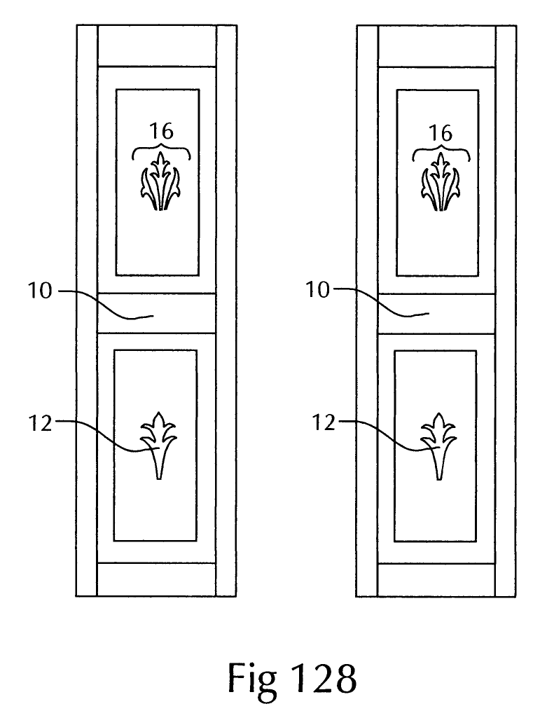

As shown by example in FIG. 128, a plurality of exterior shutters 10 is provided along with plurality of decorative ensembles 16 and ornaments 12, each decorative ensemble 16 and ornament 12 further having a selected decoration. At least one of the decorative ensembles 16 having a selected decoration is permanently attached to one of the exterior shutters 10 and at least one of the ornaments 12 having a different selected decoration is permanently attached to the same exterior shutter 10, wherein the selected decorations are directed to a theme. The permanent attaching of decorative ensembles 16 and ornaments 12 is repeated on the other exterior shutter 10 within the at least one set to present a display system related to the theme.

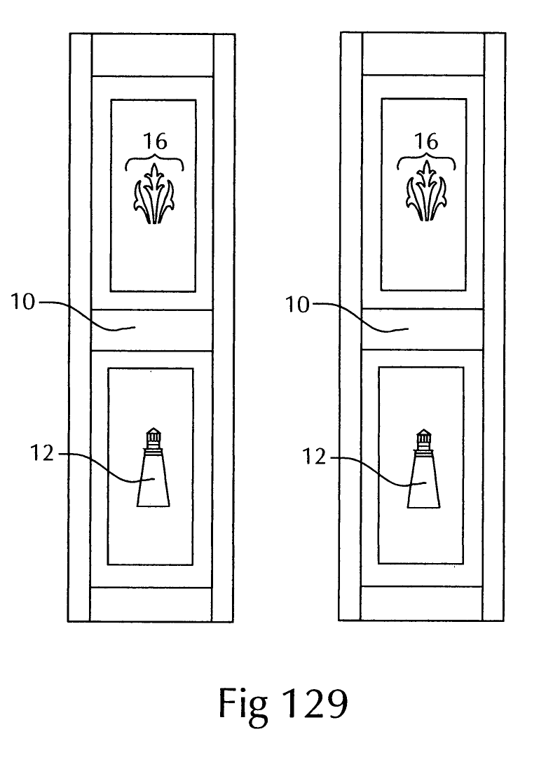

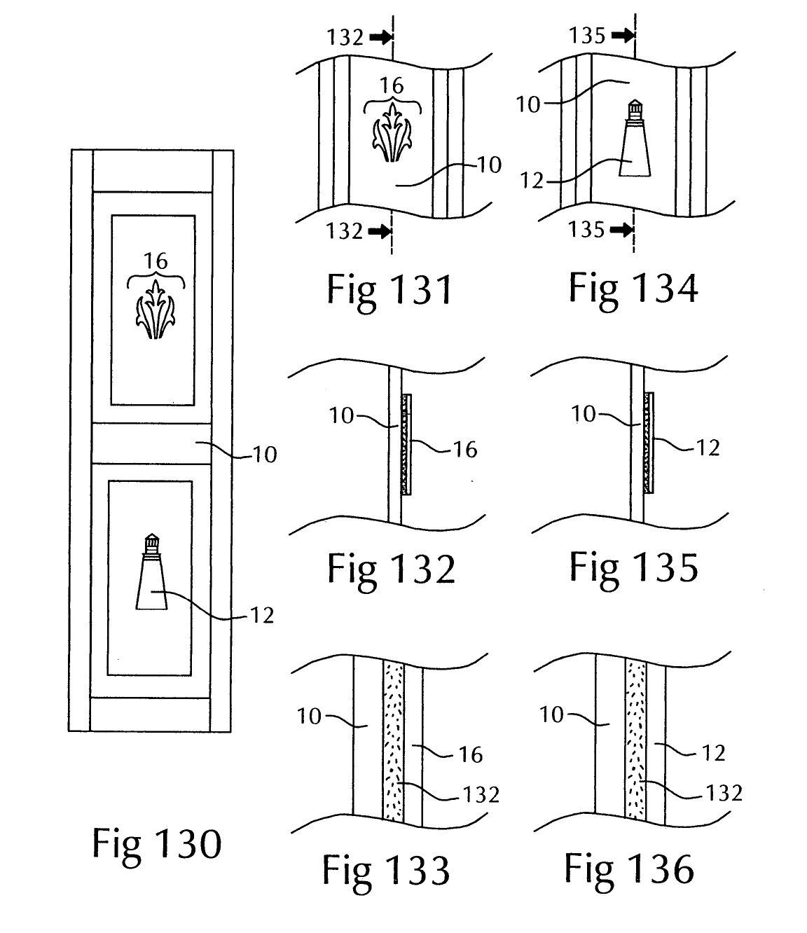

As the example of FIG. 129 shows, a plurality of exterior shutters 10 is provided along with a plurality of decorative ensembles 16 and ornaments 12, the decorative ensembles 16 and ornaments 12 each further having a selected decoration. At least one of the decorative ensembles 16 having a selected decoration is permanently attached to one of the exterior shutters 10, and at least one of the ornaments 12 having a different selected decoration is permanently attached to the same exterior shutter 10 wherein the selected decorations are directed to at least two different themes, which further aesthetically compliment each other. The permanent attaching of decorative ensembles 16 and ornaments 12 is repeated on the other exterior shutter 10 within the at least one set to present a display system related to at least two different themes, which are further aesthetically complimenting of one another. FIG. 130 shows an example of one of the exterior shutters 10, which was used in FIG. 129 having one decorative ensemble 16 and one ornament 12 thereon. FIGS. 131-136 show examples of how the ornaments 12 and/or decorative ensembles 16 of the present invention may be permanently attached to at least a portion of at least planar surface or surfaces which may be on, or about the outer face of each of the exterior shutters 10 within the at least one set to further provide, using the methods previously disclosed herein, permanent surface treatments for exterior shutters 10. Attachment means such as, for example, adhesives, glues, epoxies, and cements 132, may be used to permanently attach at least a portion of at least planar surface which may be on, or about the inner face of each of the ornaments 12 and/or decorative ensembles 16 to at least a portion of at least planar surface or surfaces which may be on, or about the outer face of each of the exterior shutters 10 within the at least one set, using any desirable method selected from the seven methods of surface treatment previously disclosed herein whereby further providing many options when permanently treating at least a portion of at least planar surface or surfaces which may be on the outer face of each of the exterior shutters 10 within the at least one set. These are by no means the only permanent attachment means, which may be used to attach the interchangeable ornaments 12 and/or decorative ensembles 16 to at least a portion of at least planar surface or surfaces which may be on the outer face of each of the exterior shutters 10 within the at least one set. Other permanent attachment means such as, for example, screws or similar like fasteners, male connecters, male and female connecters, nails, rivets, wires, ties, hot melts, lamination, heating, stitching or sewing, soldering, welding, bonding, machine or industry processes known in the art, or other attachment means known in the art, may alternately be used to permanently attach the ornaments 12 and/or decorative ensembles 16 to at least a portion of at least planar surface or surfaces which may be on, or about the outer face of each of the exterior shutters 10 within the at least one set. The ornaments 12 and/or decorative ensembles i 6 which may be permanently attached to exterior shutters 10 in the manor described above are obviously afforded all of the amenities that the ornaments 12 are afforded as disclosed herein. Therefore, the permanent surface treatments for exterior shutters 10 as disclosed above may easily be made, in three dimensional form, to glow in the dark using any suitable photoluminescent like material or materials, further having applicable embodiments of the present invention removably attached thereto, or may further utilize any of the other advantages which are inclusive in the amenities afforded the ornaments 12 or any principles and/or applications thereof which may be further related to the present invention as disclosed herein. The permanent surface treatments for exterior shutters 10 disclosed above may alternately be painted or printed on the exterior shutter 10, or may be made on or about the exterior shutter 10 by other means known to those skilled in the art.

The seven methods of permanent surface treatment disclosed above may also be converted, to seven methods of decorating at least one set of exterior shutters 10 by changing the terms permanent and permanently, which was used therein to describe how the ornaments 12 and/or decorative ensembles 16 were attached to the exterior shutters 10, to removable and/or removably.

The ornaments 12 and/or other applicable embodiments, or any principles and/or applications thereof which may be further related to the present invention may be used for improving the exterior appearance of a house having exterior shutters 10 adjacent to windows in an easy to change fashion as the example previously shown in FIGS. 1-2 may alternately represent. A plurality of at least ornaments 12 is provided, the ornaments 12 each having selected decorations, which collectively represent a regal or majestic like theme. At least one ornament 12 is attached to at least a portion of at least planar surface which may be on, or about the outer face each of the exterior shutters 10 of the house wherein the selected regal or majestic like decorations collectively represent a theme and further present a changeable regal or majestic like display system related to the theme upon the exterior shutters 10 of the house which still further projects a visual regal or majestic like display which may be seen at a substantial distance from the house by a person or persons. All of the ornaments 12 are removed from the exterior shutters 10 at a substantially later date, or when desired. The steps laid out herein are repeated as often as desired using similar regal or majestic like theme oriented decorations, whereby the changeable regal or majestic like display system presented on the exterior of the house can be quickly and easily changed to display similar regal or majestic like themes for the purpose of improving the exterior appearance of the house.

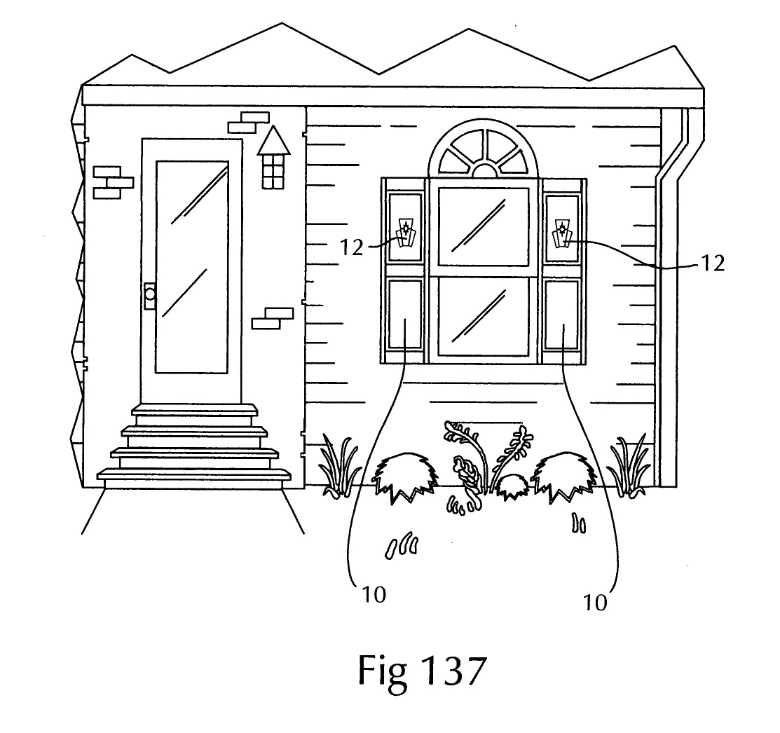

As shown in the example of FIG. 137, the ornaments 12 and/or other applicable embodiments, or any principles and/or applications thereof, which may be further related to the present invention, may be used to provide a changeable exterior appearance for a window having exterior shutters 10 adjacent thereto. A plurality of at least ornaments 12 is provided having selected decorations, which collectively represent a theme. As shown in the example of FIG. 137, at least one ornament 12 having a selected decoration is attached to at least a portion of at least planar surface which may be on, or about the outer face of one of the exterior shutters 10, and at least a second ornament 12 having the same selected decoration is attached to at least a portion of at least planar surface which may be on, or about the outer face of the other exterior shutter 10, wherein the selected decorations collectively represent a theme and a changeable display system related to the theme is presented on the exterior shutters 10 adjacent to a window. All of the ornaments 12 are removed from the exterior shutters 10 at a substantially later date, or as desired. The steps laid out herein are repeated as desired using different selected decorations, whereby a changeable exterior appearance for a window having shutters 10 adjacent thereto is provided.

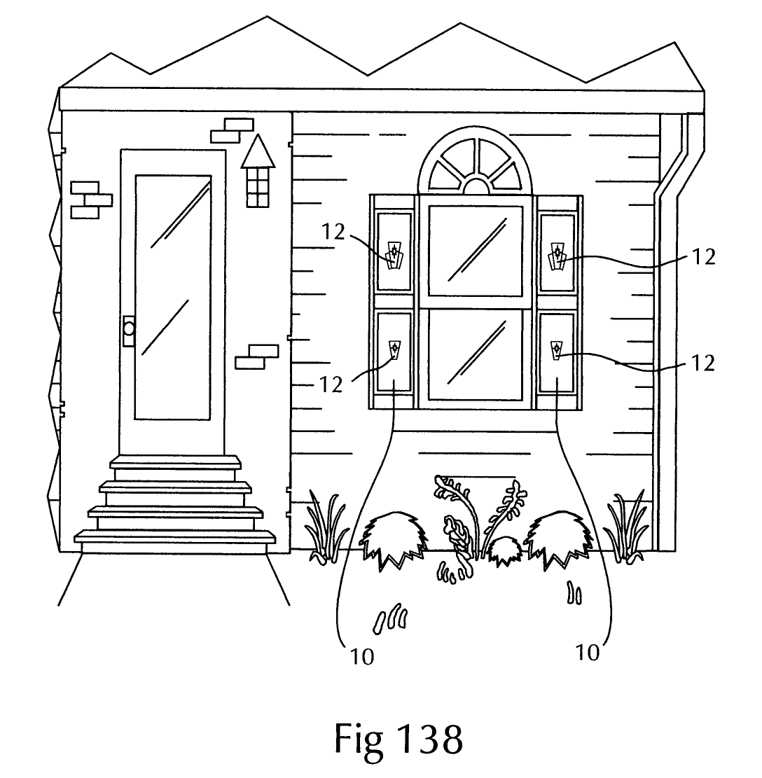

As shown in the example of FIG. 138, the ornaments 12 and/or other applicable embodiments, or any principles and/or applications thereof, which may be further related to the present invention may be used to provide a method of decorating the exterior appearance of a window having exterior window shutters 10 adjacent thereto. A plurality of at least interchangeable ornaments 12 is provided having selected decorations, which collectively represent a theme. One ornament 12 having a selected decoration, attached to at least a portion of at least planar surface, which may be on, or about the outer face of one of the exterior shutters 10. At least a second ornament 12 having a different selected decoration is attached to at least a portion of at least planar surface, which may be on, or about the outer face of the same exterior shutter 10 wherein the selected decorations are directed to a theme. The attaching of ornaments 12 having at least the same two selected decorations is repeated on at least a portion of at least planar surface, which may be on, or about the outer face of the other exterior shutter 10 to present a display system related to the theme.

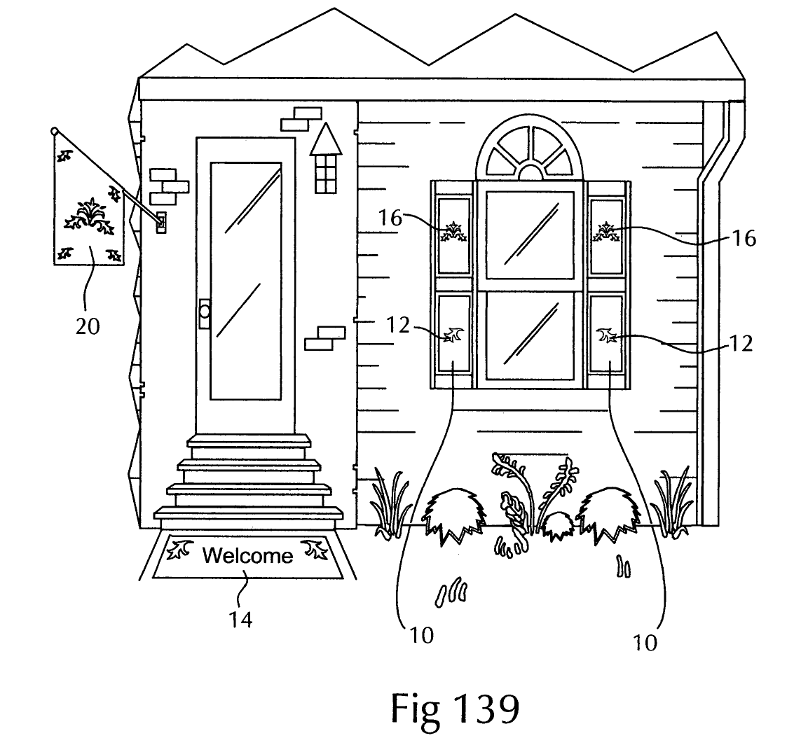

As shown in FIG. 139, the ornaments 12 and/or other applicable embodiments, or any principles and/or applications thereof which may be further related to the present invention, may be used in combination with other common products that may be decorative such as, for example, at least a decorative house flag 20, to coordinate a thematic display for the exterior of a house having exterior shutters 10 thereon. A plurality of at least ornaments 12 and a decorative house flag 20 are provided having selected decorations which collectively represent a theme, the decorative house flag 20 having at least a predetermined shape and/or at least a portion of decorative surface thereof, and a pole. At least one ornament 12, having a selected decoration is attached to at least a portion of at least planar surface, which may be on, or about the outer face of each of the exterior shutters 10 of a house, wherein the selected decorations collectively represent a theme, and a changeable display system is presented related to the theme. The pole, and decorative house flag 20 having a selected decoration is mounted on the house or porch thereof wherein the decorative house flag's 20 selected decoration is directed to the theme that the ornaments 12 are presenting in a changeable display system on the exterior shutters 10 of the house to further present a coordinated thematic display for the house. Other common products which may be decorative may also be used in combination the at least interchangeable ornaments 12 in a similar manor to coordinate a thematic display for a house or property such as, for example, a door mat 14, plaques, mail box covers, garden flags, yard signs etc.

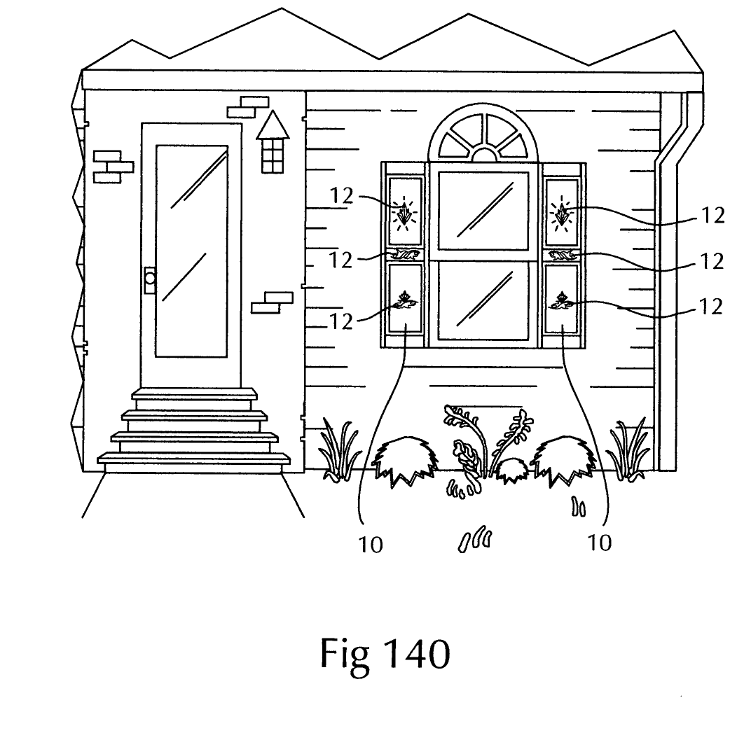

FIG. 140 shows an example of how a combination day and night display system may be presented on at least one set of exterior shutters 10 adjacent to at least one window of a house wherein the daytime display may present an entirely different display than the nighttime display. A plurality of ornaments 12 and/or other applicable embodiments, or any principles and/or applications thereof, which may be further related to the present invention, is provided. The ornaments 12 each having selected decorations, which collectively represent at least one theme, and at least two of the ornaments 12 further having photo-luminescent like qualities. One of the ornaments 12 having a selected decoration and photo-luminescent like qualities is attached to one of the exterior shutters 10 adjacent to the at least one window. At least a second ornament 12 having a selected decoration is attached to the same exterior shutter 10 wherein the selected decorations are directed toward a theme. At least the two same like ornaments 12 are attached to the other exterior shutter 10 in a balanced fashion to present a display system related to the at least one theme, whereby the day and night display system may present at least two entirely different displays for example, during the daytime, all of the at least four ornaments 12 are collectively visible and further presenting a display upon the exterior shutters 10, and at nighttime an entirely different luminous display is presented wherein only the at least two ornaments 12 having photo-luminescent like qualities are visible and are still further presenting a substantially different display upon the same set of exterior shutters 10 as compared with the daytime display. The ornaments 12 and/or other applicable embodiments, or any principles and/or applications thereof which may be further related to the present invention, may be used as desired to present a variety of alternate options for the day and night display system as disclosed above, or for all that was previously disclosed herein.

### CONCLUSIONS, RAMIFICATIONS, AND SCOPE OF INVENTION

While my above description contains many specificities, these should not be construed as limitations on the scope of the invention, but rather as an exemplification of the preferred embodiments thereof. Many other variations are possible. For example, pertaining to the application of the present invention and the methods further produced thereby, any of the principles and/or applications thereof, which are further related to the present invention may be used in any desirable fashion, or any suitable combinations thereof and further be presented in a display system on at least one set of exterior shutters. As shown in the discussion of the prior art, exterior shutters may have a decorative shape cut out of a facial portion thereof to provide a permanent decoration. The principles and/or applications thereof, which may be further related to the present invention may be used in any desirable combination to present a display on exterior shutters having permanent decorative cutouts wherein the principles and/or applications further related to the present invention may be used to present any desirable displays which may work in any suitable combination with the predetermined cutout shape and/or shapes which may be on or about such exterior shutters.

The ornaments of the present invention may acquire any suitable functionality, which is commonly embodied in other decorative products that are currently sold on the market for different decorative purposes. Pre-existing technologies, which are vastly a part of the decorating industries, such as simple lighting circuits having a power source, wired to a switch, and/or lighting means, flashing circuits and similar sequence circuits, means for producing sound, songs, and recorded messages which may be activated by sound, light, or motion sensors, decorative products having pockets or pouches for holding flowers or similar like items, doors with movable hinges, or doors which are slidably mounted in a decoration, and other similar like functionalities which are well known in the art may easily be adapted to the present invention. These types of available modifications and others known to those skilled in the art which may be similar yet vast in nature, should be known as foreseeable to those skilled the art and are not to be seen as an unforeseen improvement to the present invention.

Of course the present invention is not intended to be restricted to any particular form or arrangement, any specific material, any specific way to make the invention, specific embodiment disclosed herein, or any specific use, since the same may be modified in various particulars or relations without departing from the spirit or scope of the claimed invention hereinabove shown and described of which the embodiments shown, most of which are shown in a sheeted form for the sake of simplicity and clarity, are intended only for illustration and for disclosure of at least one operative embodiment and not to show all of the various forms or modification in which the present invention might be embodied or operated.

The present invention has been described in considerable detail in order to comply with the patent laws by providing full public disclosure of at least one of its forms. However, such detailed description is not intended in any way to limit the broad features or principles of the present invention, or the scope of patent monopoly to be granted.

Accordingly, the scope of the invention should be determined not by the embodiments illustrated and the descriptions thereof, but by the appended claims and their legal equivalents.

What is claimed is:

1. An ornament for an exterior shutter made of any suitable plastics, woods, metals or the like, and further having an inner face, an outer face, and side edges adjacent the inner and outer face, the inner face and outer face further having at least portions of at least planar surface thereof, comprising:
at least one decorative element consisting of at least a portion of suitable material,
the at least portion of material having at least a predetermined shape and/or at least a portion of decorative surface thereof, an inner face, and an outer face, and a structural size which is substantially smaller in relation as as compared to the height and width dimensions of the exterior shutter,
means for at least removably attaching at least a portion of at least planar surface which may be on, or about the inner face of the ornament to at least a portion of at least planar surface, which may be on, or about the outer face of the exterior shutter.

2. The ornament of claim 1, wherein the means for removably attaching at least a portion of at least planar surface, which may be on, or about the inner face of the ornament to at least a portion of at least planar surface which may be on or about the outer face of the exterior shutter is selected from the group consisting of pressure sensitive adhesives, adhesive tapes, strips, or pads, hook and loop fasteners, static cling, water-washable tacky elastomer, adhesive tabs, aerosol adhesives, suction cups or similar like suction cup devices, clamp like members or devices, male and female connectors, snaps, pins and pegs, clasps, brackets, channels, bars and grooves, or friction fit devices.

3. The ornament of claim 1, further capable of receiving at least one ornament which may be removably attached to at least a portion of at least planar surface which may be on, or about the outer face thereof.

4. The ornament of claim 1, further capable of receiving at least two ornaments which may be removably attached individually and/or in a layered fashion to at least a portion of at least planar surface which may be on, or about the outer face thereof.

5. The ornament of claim 1, further capable of receiving three or more ornaments which may be removably attached individually and/or in a layered fashion to at least a portion of at least planar surface which may be on, or about the outer face thereof.

6. The ornament of claim 1, wherein the ornament is flexible.

7. The ornament of claim 1, wherein the ornament is rigid.

8. The ornament of claim 1, wherein the ornament has a length and width.

9. The ornament of claim 1, wherein the ornament has a length, width, and depth.

10. The ornament of claim 3, having at least one ornament removably attached to at least a portion of at least planar surface which may be on, or about the outer face thereof, further having means for permanently attaching at least a portion of at least planar surface which may be on, or about the inner face thereof to at least a portion of at least planar surface which may be on, or about the outer face of the exterior shutter, wherein at the point of permanent attachment, the ornament of claim 3 is converted to an ornamental base mount, whereby a permanent ornamental base is presented on the shutter further having all the amenities that are afforded the ornament from which the ornamental base mount was converted.

11. The ornament of claim 10, wherein the means for permanently attaching at least a portion of at least planar surface which may be on, or about the inner face of the ornamental base mount to at least a portion of at least planar surface which may be on, or about the outer face of the exterior shutter is selected from the group consisting of permanent adhesives, glues, epoxies, cements, staples, screws or similar like fasteners, male connectors, male and female connectors, nails, rivets, wires, ties, hot melts, lamination, heating, stitching or sewing, soldering, welding, bonding, or machine industry processes.

12. The ornament of claim 1, and further comprising a plurality of ornaments which may be removably attached in a predetermined grouping on, or about at least a portion of at least planer surface which may be at least on the outer face of the exterior shutter, each ornament within the grouping is positioned in a close proximity in relation to the other ornaments within the grouping, wherein all of the ornament's at least predetermined shapes and/or at least portions of decorative surface thereof further cooperate collectively as a group to present a single display or decorative ensemble.

13. The ornament of claim 12, further having means for permanently attaching at least a portion of at least planar surface which may be on, or about the inner face of the decorative ensemble to at least a portion of at least planar surface which may be on, or about the outer face of the exterior shutter, wherein at the point of permanent attachment, the decorative ensemble is further converted to a permanent surface treatment for the exterior shutter.

14. The ornament of claim 13, wherein the means for permanently attaching at least a portion of at least planar surface which may be on, or about the inner face of the decorative ensemble to at least a portion of at least planar surface which may be on, or about the outer face of the exterior shutter is selected from the group consisting of permanent adhesives, glues, epoxies, cements, staples, screws or similar like fasteners, male connectors, male and female connectors, nails, rivets, wires, ties, hot melts, lamination, heating, stitching or sewing, soldering, welding, bonding, or machine industry processes.

15. The ornament of claim 1, further comprising photo-luminescent like qualities.

16. As an article of manufacture, at least one set of exterior shutters made from any suitable plastics, woods, metals, or the like that are further manufactured, packaged, and shipped to a distributor or consumer having a plurality of at least ornaments which are still further at least removably attached to at least portions of at least planar surface which may be on, or about the outer face of the at exterior shutters comprising:
at least one set of exterior shutters, each exterior shutter within the set having an inner face, an outer face, and side edges adjacent the inner face and outer face, the inner face and outer face further having at least portions of at least planar surface thereof,
means for attaching the at least one set of exterior shutters to the exterior of a house adjacent to at least one window,
a plurality of at least ornaments having selected decorations which collectively represent at least one theme, the ornaments each further having at least a predetermined shape and/or at least a portion of decorative surface thereof, an inner face, and an outer face, and a structural size which is substantially smaller in relation as compared to the height and width dimensions of the exterior shutter,
means for at least removably attaching at least a portions of at least planar surface which may be on, or about the inner face of the at least ornaments to at least portions of at least planar surface which may be on, or about the outer face of the exterior shutters in a manor which does not substantially alter the process of manufacturing, packaging, or shipping the set, or sets of exterior shutters to the distributor or consumer,
whereby affording the consumer a unique decorating alternative, wherein the consumer may choose from a wide selection of pre-decorated, theme oriented sets of exterior shutters when opting to improve and/or change the appearance of their house, the consumer may further dispose the at least one set of exterior shutters on the exterior of their house adjacent to at least one window, wherein the at least one set of exterior shutters in combination with the ornaments having selected decorations which collectively represent a theme, further cooperate collectively to present an instant changeable display system upon the exterior of the house that may be easily changed as desired.

17. The article of manufacture of claim 16, further comprising a plurality of ornamental base mounts which may be permanently attached to at least portions of at least planar surface which may be on, or about the outer face of the exterior shutters.

18. The article of manufacture of claim 16, further comprising a plurality of decorative ensembles which may be removably attached to at least portions of at least planar surface which may be on, or about the outer face of the exterior shutters.

19. The article of manufacture of claim 18, further comprising a plurality of decorative ensembles which may be permanently attached to at least portions of at least planar surface which may be on, or about the outer face of the exterior shutters to further present a permanent surface treatment for the exterior shutters.

20. The article of manufacture of claim 19, further comprising a plurality of ornaments in combination with a plurality of decorative ensembles which may each be permanently attached to at least portions of at least planar surface which may be on, or about the outer face of the exterior shutters to present a permanent surface treatment for the exterior shutters.

21. The article of manufacture of claim 16, further comprising at least 4 ornaments, which may each be permanently attached to at least a portion of at least planar surface, which may be on, or about the outer face of the exterior shutters comprising the at least one set to present a permanent surface treatment for the exterior shutters, wherein one ornament having a selected decoration is permanently attached to one of the shutters, at least a second ornament having a different selected decoration is permanently attached to the same exterior shutter wherein the selected decorations are related to a theme, at least two ornaments having the same selected decorations are permanently attached to the other exterior shutter to present a permanent display system related to the theme.

22. A method of providing a changeable decorative appearance for a window having exterior window shutters made of any suitable plastics, woods, metals, or the like adjacent thereto comprising the steps of:
providing a plurality of removable ornaments having selected decorations which collectively represent a theme, each ornament further having at least a predetermined shape and/or at least a portion of decorative surface thereof, an inner face and an outer face, and a structural size which is substantially smaller in relation as compared to the height and width dimensions of the exterior shutter,
attaching at least a portion of at least planar surface which may be on, or about the inner face of one ornament having a selected decoration to at least a portion of at least planar surface which may be on, or about the outer face of one of the exterior shutters,
attaching at least a portion of at least planar surface which may be on, or about the inner face of at least a second ornament having a different selected decoration to at least a portion of at least planar surface which may be on, or about the outer face of the same exterior shutter, wherein the selected decorations are directed to a theme,
repeating the attaching of ornaments having at least the same at least two selected decorations on at least a portion of at least planar surface which may be on the outer face of the other exterior shutter to present a display system related to the theme,
removing the ornaments at a substantially later date or as desired to change the presented decorative theme for the window and/or the home.
